(19) United States
(12) Patent Application Publication
(10) Pub. No.: US 2012/0290427 A1
(43) Pub. Date: Nov. 15, 2012

(54) Apparatus and Method for Managing a Trust Network

(75) Inventors: Drummond Shattuck Reed, Seattle, WA (US); Joseph Edward Johnston, San Francisco, CA (US); Marc Coluccio, Kirkland, WA (US); Barry Ian Forman, Seattle, WA (US)

(73) Assignee: RESPECT NETWORK CORPORATION, San Francisco, CA (US)

(21) Appl. No.: 13/466,921

(22) Filed: May 8, 2012

Related U.S. Application Data
(60) Provisional application No. 61/484,159, filed on May 9, 2011.

(51) Int. Cl. G06Q 30/00; G06Q 40/00; G06F 15/173

(52) U.S. Cl. 705/26.2; 709/223; 705/35; 705/26.43

(57) ABSTRACT

A computer readable storage medium includes instructions to receive a request from a client to enroll in a trust network. A registration form is supplied to the client in response to the request. Client data in the registration form received from the client is processed to load the client data as parameters in a managed trust network. The managed trust network includes a vouch system, a complaint resolution mechanism, relationship value exchange and endorsements.

### CROSS-REFERENCE TO RELATED APPLICATION

This application claims priority to U.S. Provisional Patent Application Ser. No. 61/484,159, filed May 9, 2011, entitled “Apparatus and Method for Managing a Trust Network”.

### FIELD OF THE INVENTION

This invention relates generally to digital data processing. More particularly, this invention relates to techniques for managing a trust network.

### BACKGROUND OF THE INVENTION

The Internet has become the common network connecting many other types of digital networks and devices for communications and data interchange. The increased use of the Internet has led to an increase in the number of applications and services running on it, the number and value of transactions taking place over it, and the number and types of relationships that can be formed and maintained through it. Each of these has in turn increased the importance of trust in online activities. A number of technologies and services have been developed to meet this need.

One of the earliest approaches to establishing online trust relationships in an open network like the Internet is peer-to-peer reputation systems. These have the advantages of high scalability and efficiency and do not require central trust authorities. However these systems are subject to a number of attacks as documented in Josang, A.; Ismail, R.; Boyd, C. (2007). “A Survey of Trust and Reputation Systems for Online Service Provision”. Decision Support Systems 43. Perhaps the best known attack is called the “Sybil attack” after the famous case of multiple-personality disorder. In a Sybil attack the attacker creates a significant number of pseudonymous digital identities (“sock puppets”) and then uses them to gain disproportionately large influence. Another paper by A. Cheng and E. Friedman. Sybilproof reputation mechanisms SIGCOMM Workshop on Economics of Peer-to-Peer Systems, 2005, distinguishes between “symmetric” and “asymmetric” reputation systems. A symmetric system is one where all nodes of the reputation graph are considered equal from the standpoint of computing reputation. In their conclusion, they state, “We have shown that no nonconstant, symmetric reputation function exists.” In other words, if all nodes are treated as equal starting points for computing trust, it is impossible to defend from Sybil attacks. However they show that it is relatively easy to defend against Sybil attacks if the reputation graph is not symmetric, which can be done “when we can identify some trusted user, or when each user computes separately the reputations of other users with respect to themselves.” This approach is often referred to as creating a “web-of-trust” and was described by Phillip Zimmermann in the documentation for his 1992 encryption software program PGP (Pretty Good Privacy). He envisioned a series of in-person key-signing parties where, “As time goes on, you will accumulate keys from other people that you may want to designate as trusted introducers. Everyone else will each choose their own trusted introducers. And everyone will gradually accumulate and distribute with their key a collection of certifying signatures from other people, with the expectation that anyone receiving it will trust at least one or two of the signatures. This will cause the emergence of a decentralized fault-tolerant web of confidence for all public keys.” However two decades have passed and this idea has not been implemented at any significant scale; no sizable peer-to-peer web of trust has emerged.

A second class of solutions is federated digital identity technologies, so-called because they represent a federated network of authorities whose authentication or authorization assertions about a digital identity may be trusted by others in the network. These protocols and standards aim to extend familiar enterprise security concepts such as single sign-on to cross-domain security and trust relationships on the Internet. Examples include the Security Assertion Markup Language (SAML), an open standard from the Organization for Structured Information Standards (OASIS) SAML Technical Committee; the OpenID federated single-sign-on protocol from the OpenID Foundation; the OAuth distributed authorization protocol from the Internet Engineering Task Force (IETF); and the Identity Metasystem Interoperability (IMI) protocol from the OASIS IMI Technical Committee. While years of industry effort have gone into the development of these protocols, and some adoption has occurred, they have not achieved the broad adoption their architects intended. Drawbacks include both technical complexity, difficulty of interoperability, and lack of business incentives for adoption.

Much greater adoption has been achieved by social networks. Facebook™, Twitter™, LinkedIn™, and other modern social networks have hundreds of millions of members. As a result they have been able to deploy federated identity solutions that have started to achieve significant adoption. An example is Facebook Connect, which provides a mechanism for websites to obtain third-party authentication of a user from Facebook as well as authorization for transfer of specific personal data and social graph information from the user's Facebook account. A website may that integrates Facebook Connect may also obtain authorization to message back to the user's Facebook account to notify the user about new content and events or share information with others in the user's social graph. However the success of Facebook and other social networks has raised significant privacy concerns. They have become very large centralized repositories of personal data, which is a privacy concern in itself. Their privacy controls are complex and hard to understand, which results in relatively little usage of these controls. They have a significant number of privacy defaults set to “public” or “share”, which results in a generally low expectation of privacy and data protection. They also have a business model that motivates the social network to serve as an intermediary between the social network's users and businesses that wish to form relationships with these users. Because the social network earns a profit on its knowledge of user's data, it is not incented to enable direct relationships between users and businesses even if it may be done at lower cost and provide higher value and greater control to both the user and the business.

From the perspective of a business, the Internet represents an opportunity to extend a customer relationship management (CRM) system out towards the customer. CRM systems enable businesses to aggregate data about a customer from all touchpoints within an enterprise and also from external sources. As social networks have grown in popularity, a new branch of the CRM industry has developed called social CRM. Social CRM systems such as those offered by Salesforce.com™ and SugarCRM™ connect conventional CRM backend systems with data feeds from social networks such as Facebook and Twitter in order to reflect customer feedback and sentiment about a business and its products or services. Although there is strong market interest in social CRM systems, a primary weakness of these systems is that they do not actually extend or enhance a relationship directly with the customer. There are multiple reasons for this. First, social CRM systems are an extension of CRM systems that are intended to be operated entirely under the control of an enterprise and its employees or contractors. Therefore, they do not provide controls or authorization mechanisms for the safe exchange of customer data directly with a customer. Secondly, user relationships, interactions, and expectations on a social network are defined by a social context, so the introduction of commercial relationships and values is often inappropriate, out-of-context, or even intrusive. Thirdly, neither social CRM systems or social networks have the legal or trust frameworks that facilitate the sharing of information across security and privacy boundaries. Lastly, neither CRM systems nor social networks were designed to facilitate a measurable exchange of value between businesses and users that corresponds to the value of the digital relationship they share.

Given the very large and persistent need for businesses to connect with customers, however, other solutions have emerged to facilitate this type of connection. One such solution is a customer network: a form of specialized social network dedicated to solving problems and issues shared by customers of one or more businesses. Some customer networks, such as GetSatisfaction™ and UserVoice™, provide customer service and product feedback services across a large number of businesses. Others, such as Lithium™ and Jive™, offer software and services for managing a dedicated community of customers for a single business or business ecosystem. While customer networks provide a commercial context for group activities, such as customers answering each other's questions or ranking the priority of new features for a product, they do not solve the aforementioned deficiencies of either CRM systems or social networks. For example, each new customer network a user needs to join in order to interact with a different business requires the user to register and manage a new set of account credentials, profile data, and social relationships. The user must also develop and manage a new reputation on each customer network. In addition, while dedicated customer networks may help facilitate direct data sharing and relationship management with the business they serve, the proprietary nature of this relationship means that this data and set of social relationships are not easily portable and reusable with other business relationships.

Certain types of information are so valuable for sharing electronically between individuals and businesses that specialized networks have evolved for this purpose. One example is health information exchange networks such as the U.S. National Health Information Network (NHIN). With NHIN, an individual can manage the exchange of electronic health record (EHR) data with physicians, hospitals, and other health care providers. The value of this form of personal data control and digital information transfer is very high, and demand for these services is growing. However because of the specialized nature of the data and the network participants, they do not address the need for other digital relationship management services or relationship value exchange. In addition, since they are dealing with extremely sensitive data in a highly regulated industry, their trust infrastructure is relatively rigid and dependent on established industry and governmental certification programs.

As the Internet has grown and many new businesses and industries have come online, the need for more flexible and adaptable trust mechanisms has increased. In particular many Internet e-commerce, search, content management, and recommendation sites have instituted reputation systems. These systems obtain feedback from users and users activities to assign them reputation for purposes of moderating and ranking content, filtering messages, and motivating contributions and good behavior. One drawback shared by site-specific reputation systems is that the reputation scores and other metadata they produce are not portable across sites, domains, or contexts. In addition to technical barriers, there can also be legal barriers. For example, eBay™ does not permit the user of its buyer and seller reputations on other websites. This lack of cross-context portability and applicability of reputation metrics is a significant hindrance to the establishment of trust in Internet and Web applications that need to cross multiple trust boundaries.

Another approach to cross-context reputation is aggregating reputation metrics from multiple contexts and systems into a consolidated algorithmic scoring system. This is the approach taken by companies such as Klout™ and PeerIndex™, basing their scores of “social influence” on factors including number of followers and retweets on Twitter, number and rank of friends on Facebook, and number and rank of connections on LinkedIn. While these approaches produce a consolidated reputation metric, and this metric can to some degree be contextualized by topic, these reputation scoring systems are not themselves reputation systems or relationship management systems. For example, the only way to affect one's reputation is to take actions in other systems that are used to calculate one's score. Users also do not have a direct way to input or express the contexts in which they are interested or active, nor can they enter into or manage relationships and perform exchanges of relationship value. Finally, because these scoring systems are external to the systems from which the score is derived, and only available under certain licensing arrangements, they are not uniformly available to applications that need to consume reputation metrics across a wide population of users.

The problem of creating and sustaining online trust networks is also closely related to the improvement of e-commerce, online advertising, and electronic value exchange networks. As discussed above, all of these systems depend on trust to facilitate the acquisition, motivation, and action of customers who are the ultimate targets of every business. eBay™ is an exemplary case: the success of its market-leading online auction service is closely tied to the success of its reputation system based on buyer/seller feedback. A 2004 paper called “The Value of Reputation on eBay: A Controlled Experiment” by Paul Resnick, Richard Zeckhauser, John Swanson, and Kate Lockwood, based on research supported by National Science Foundation grant number IIS-9977999, showed that a positive eBay reputation could be translated into a measurable economic benefit: a seller could command a 8.1% increase in the price buyers were willing to pay. This value is now being extended to social influence scores. In a Sep. 30, 2010 article entitled, “Need a Reservation? That Could Depend On How Big You Are on Twitter (Really)”, AdAge Digital reported that the Palms Hotel and Casino in Las Vegas was using a guest's Klout score to determine the level of amenities that would be offered to the guest. A significant drawback of this approach is that it does not reflect the value of the guest to the hotel or of the hotel to the guest, but is derived externally to this relationship. Social networks have also developed “social currencies” such as Facebook™ Credits to enable their users to easily exchange value for virtual goods and services available on or through the social network. However, the applicability of such a social currency to relationship value exchange between users of the social network and businesses who want to form direct relationships with those users is subject to the same drawbacks discussed above.

Other online and offline markets that could be significantly enhanced by integration with portable, cross-context, trusted reputation metrics include advertising auction systems such as Google™ AdWords™ search keyword advertising auction system; online advertising networks such as Google™ AdSense™ and Yahoo™ Publisher Network; and group buying systems such as GroupOn™ and LivingSocial™ The key challenge across all of these systems is how reputation metrics can be integrated in a way that is both trusted by customers and businesses alike and which produces rewards that maximize the value for both the customer and the business. In addition, group buying systems are currently based on offers generated by businesses and distributed to potential customers who form a buying group. They do not address needs expressed and aggregated by customers for action by businesses because that would require a trust mechanism that does not currently exist for businesses to verify that customers within the group represent legitimate demand.

In view of the foregoing, new techniques are needed to manage a trust network.

### SUMMARY OF THE INVENTION

An embodiment of the present invention provides a system and method for connecting members of a trust network through a signaling system that provides incentives for the development and maintenance of trust relationships. The trust network includes a vouch system, a complaint resolution mechanism, relationship value exchange and endorsements.

### BRIEF DESCRIPTION OF THE DRAWINGS

FIG. 1 is a block diagram illustrating an embodiment of the present invention using a dumb client and a server.

FIG. 2 is a block diagram illustrating an embodiment of the present invention using a smart client and a server.

FIG. 3A is a key to the XDI graph notation used in subsequent figures.

FIG. 3B illustrates a conceptual example of the notation in FIG. 3A.

FIG. 4A illustrates the first portion of an example XDI graph showing properties of a digital identity for a person.

FIG. 4B illustrates the second portion of an example XDI graph showing metadata about the properties in FIG. 4A.

FIG. 4C illustrates the third portion of an example XDI graph showing versioning metadata about the properties in FIG. 4A.

FIG. 4D illustrates the fourth portion of an example XDI graph showing personas of the digital identity in FIG. 4A.

FIG. 5 illustrates an example XDI graph including a link contract.

FIG. 6 illustrates an example XDI graph representing an XDI message.

FIG. 7A illustrates the XDI message template for a signed message.

FIG. 7B illustrates an example set of XDI statements in an XDI message.

FIG. 8 illustrates the JSON serialization of the XDI message in FIG. 7B.

FIG. 9 illustrates the JSON serialization of an XDI message with a $add operation.

FIG. 10 illustrates the JSON serialization of an XDI message with a $mod operation.

FIG. 11 illustrates the JSON serialization of an XDI message with a $del operation.

FIG. 12 illustrates an example method for joining a trust network.

FIG. 13 illustrates an example of a portion of a trust framework contract.

FIG. 14A illustrates an example method for joining a trust network using multiple data service providers.

FIG. 14B illustrates an extension of the method in FIG. 14A to provide additional registration protection.

FIG. 15 illustrates a method for registering a smart client with a trust network.

FIG. 16 illustrates an example XDI graph representing a vouching relationship.

FIG. 17 illustrates an example method for giving a vouch.

FIG. 18A illustrates an example user interface for performing a single vouching action.

FIG. 18B illustrates an example visual display token for indicating a vouching ratio.

FIG. 19 illustrates an example method for vouch throttling.

FIG. 20 illustrates an example trust anchor badge.

FIG. 21 illustrates an example method for issuing a complaint.

FIG. 22 illustrates an example method for complaint resolution.

FIG. 23 illustrates an example connect button.

FIG. 24 illustrates an example connect button in a connected state.

FIG. 25 illustrates an example method for establishing a connection relationship using a connect button.

FIG. 26 illustrates a continuation of the example method of FIG. 25 using a smart client.

FIG. 27 illustrates a continuation of the example method of FIG. 25 if a connection request by a dumb client is not completed in a single action.

FIG. 28 illustrates an example relationship valuation screen.

FIG. 29 illustrates an example XDI graph representing a relationship valuation.

FIG. 30 illustrates an example method for determining relationship valuation dynamically.

FIG. 31 illustrates an example method for determining relationship valuation via a market mechanism.

FIG. 32 illustrates an example XDI graph representing an endorsement relationship.

FIG. 33 illustrates an example method for issuing an endorsement.

FIG. 34 illustrates an example universal loyalty card.

FIG. 35 illustrates a example method for using a universal loyalty card.

### DETAILED DESCRIPTION OF THE INVENTION

The present invention provides a method and system for connecting members of a trust network over a digital network in order to provide incentives for the development and maintenance of trust relationships and to enable the exchange of relationship value. The trust network incents reciprocal trust relationships through a trust framework contract and signals members send to each other. It also enables relationship value exchange through a process of quantifying reputation and making it into a fungible currency.

Representations of entities participating in relationships on a digital network are commonly referred to as digital identities. The entity represented by a digital identity may be an individual person, a group of people, an organization of any type, a computing device of any type, a computer software program or service of any type, a semantic concept or category of any type, or any other type of entity requiring identification on a network.

In one embodiment the trust network is implemented using a network of clients and servers that cooperate to maintain a logical graph of information describing the relationships between members of the trust network, the data associated with each member, and the permissions each member grants to other members to access and operate on the data and relationships described in the graph.

This logical graph may be represented and serialized using many different data structures and serialization formats. In a preferred embodiment, open standard formats are used for interoperability. One such format is XML as defined by the World Wide Web Consortium in XML 1.1 (Second Edition) and XML Schemas 1.1. Another format is JSON as defined by the Internet Engineering Task Force in RFC 4627. Another format particularly suited for describing graphs is RDF (Resource Description Framework) as defined by the World Wide Web Consortium.

In an embodiment, the XDI format is used as defined by the XRI Data Interchange (XDI) Technical Committee at the Organization for the Advancement of Structured Information Standards (OASIS). While similar to and building upon the RDF format, the XDI format is used in one embodiment because the XDI graph model includes support for addressability of all nodes of the graph, modeling of contexts (graphs that contain graphs), mapping of reassignable to persistent identifiers, and a very simple grammar for describing the fundamental relationships in directed graphs. This grammar is called the XDI metagraph vocabulary. In addition XDI is also a semantic data interchange protocol defined in the XDI format. This protocol includes support for the four atomic graph operations: get (read), add (insert), modify (update), and delete. Each of these operations acts directly on a set of XDI statements in the graph, where every XDI statement represents one arc in the graph. XDI also includes support for graph structures that describe the permissions associated with other graph structures, called XDI link contracts. Link contracts are particularly useful for portable, cross-domain authorization. XDI graphs and XDI protocol messages may be serialized in any of the open standard data formats described herein. In an embodiment the JSON serialization format it used due to its simplicity, compactness, and efficiency. The XDI graph format, JSON serialization, metagraph vocabulary, protocol operations, link contracts, and messages are described in a public document published by the XDI Technical Committee called The XDI Graph Model and in other related public documents on the XDI Technical Committee website.

Both RDF and XDI are based on open standard Internet identifier formats. RDF is based on the World Wide Web and IETF Uniform Resource Identifier (URI) as defined in RFC 3986 and Internationalized Resource Identifier (IRI) standards as defined in RFC 3987. These standards define how Internet IP addresses and DNS names may be combined with local resource identifiers (such as filenames) to create hierarchical global identifiers that are the basis for the World Wide Web. This architecture has been extended by the OASIS Extensible Resource Identifier (XRI) Technical Committee standards for structured identifiers. XRI global registry infrastructure has been implemented by XDI.org as specified in the XDI.org Global Services Specifications Version 1.0 specification.

XRIs enable expression of abstract identifiers than can be composed of other XRIs as well as URIs or IRIs. Besides composition of structured identifiers, XRIs are well-suited to cross-domain information sharing because they are designed to be domain- and application-independent; they provide mechanisms for encapsulation and reuse of existing identifiers across contexts (called XRI cross-references); they support mapping of human-friendly, reassignable identifiers (referred to as i-names) to persistent, machine-friendly identifiers (referred to as i-numbers); they provide a uniform protocol for resolution of an i-name or i-number to discovery of concrete service endpoint identifiers; and this protocol includes three trusted resolution modes for security protection (HTTPS, SAML, and HTTPS+SAML).

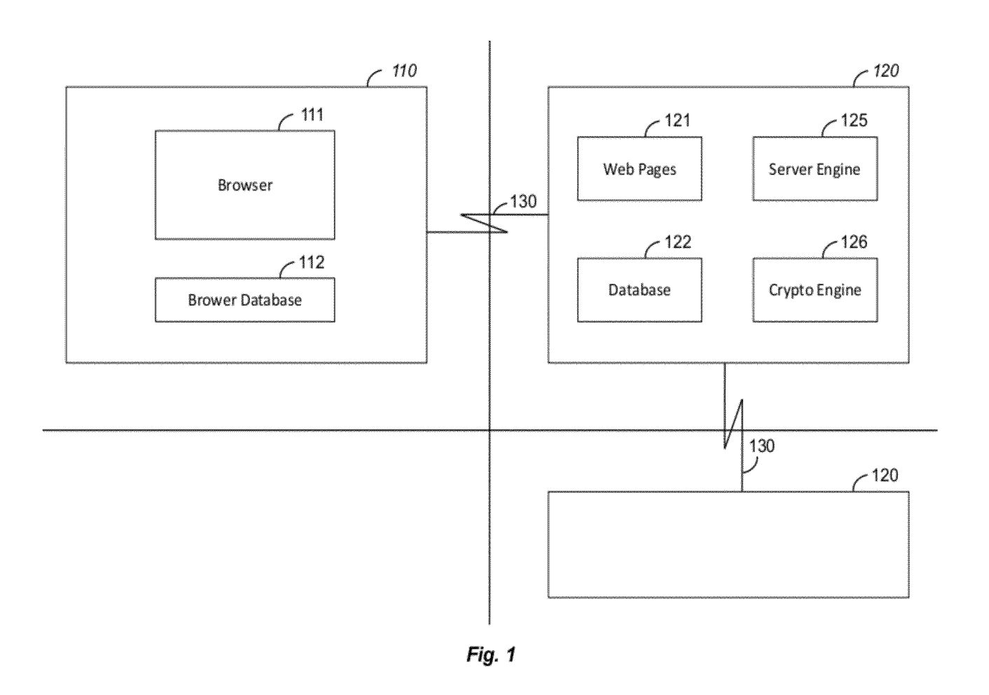

FIG. 1 illustrates an embodiment of the present invention. This embodiment uses standard client-server architecture including client 110 and server 120. In this embodiment client 110 does not include software with special-purpose capabilities for accessing or processing information from server 120, so it is referred to as a “dumb client” or “thin client”. In a dumb client embodiment, the client software used to access server 120 is a web browser 111. To save state, such as HTTP cookies or other client identifiers provided by server 120, web browser 111 includes browser database 112. Browser 111 may optionally be augmented by a plug-in module with special features for securing or displaying communications or notifications from server 120. Dumb client 210 may operate on any device containing the necessary software and communications capabilities, including desktop computers, laptop computers, smartphones, car computers, set-top boxes, or on a server 120. The type of client device is not a limiting feature of the invention.

The server 120 includes various web pages 121 for display of information, database 122 for storage of information, server engine 125 for general processing operations, and crypto engine 126 for cryptographic processing operations. Crytographic operations include generation of public/private key pairs, generation and signing of digital certificates, generation and verification of digital signatures, and encryption and decryption of incoming and outgoing messages from server 120. Client 110 and server 120 communicate over a data communication protocol 130. Multiple instances of server 120 may also communicate over data communications protocol 130. Data communications protocol 130 may be any network protocol that permits data transfer between the client 110 and server 120, including the Internet, a telephone network, a satellite network, or any other network. If the network protocol 130 is a transport level protocol such as TCP/IP, it may transport data using any desired application level protocol such as HTTP, HTTPS, SMTP, XMPP, LDAP, SIP, or XDI. The type of communications network or data communications protocol 130 is not a limiting feature of the invention.

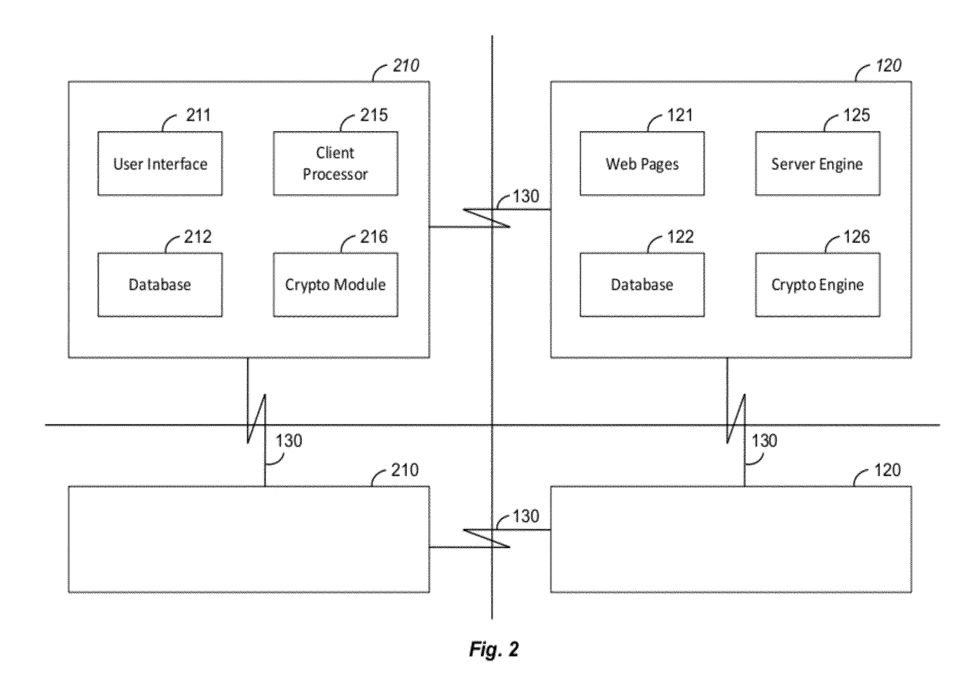

FIG. 2 illustrates an alternate embodiment of the present invention. In this embodiment, client 210 is called a “smart client” because it includes special capabilities for processing communications with server 120. Smart client 210 includes a user interface 211, a database 212, a client processor 215 for general client processing operations, and a crypto module 216 for cryptographic processing operations. User interface 211 may provide its own user display capability, or it may call another application or component on client 110 for user display and interaction. In one embodiment user interface 211 calls browser 111 in FIG. 1 for user display and interaction. In this embodiment, user interface 211 may be implemented as a local web server. In addition, browser 111 may be optionally augmented by a plug-in module with special features for securing or displaying communications or notifications from user interface 211 or from server 120. Like dumb client 110, smart client 210 may operate on any device with the necessary hardware and software. Smart client 210 communicates with server 120 over data communications protocol 130 in the same way as depicted in FIG. 1. However, because smart client 210 has the necessary capabilities to communicate on a peer-to-peer basis, in another embodiment it may communicate over communications protocol 130 with another instance of smart client 210. This peer-to-peer communications capability may have special utility with regard to discovery and establishment of new trust relationships, efficient communication directly between client devices, and secure, private transfer of data. In this fashion any configuration of smart clients 210 and servers 120 may communicate and collaborate to maintain the data structures of the present invention.

The clients 110 and 210 and servers 120 depicted in FIGS. 1 and 2 cooperate to maintain a logical graph of information describing the relationships between members of the trust network and the data, metadata, permissions, and messages they share. In an embodiment this uses an XDI graph model.

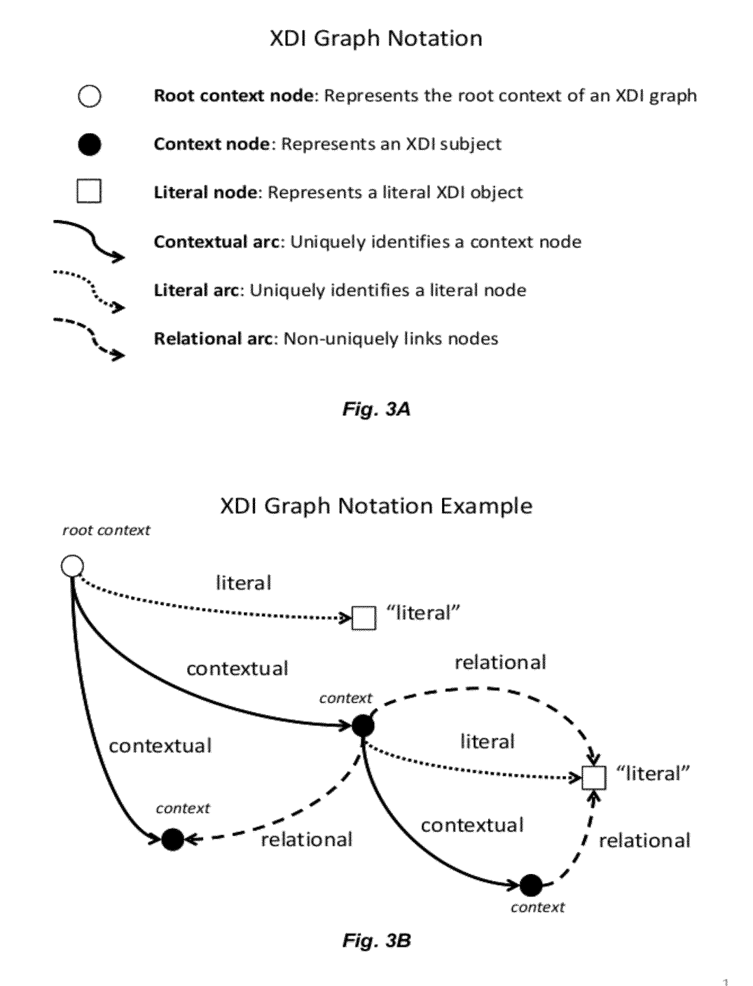

FIG. 3A is a description from The XDI Graph Model of the notation developed by the OASIS XDI Technical Committee to visually depict XDI graphs. FIG. 3B is a conceptual example from The XDI Graph Model showing how this notation is used. The functional meaning of contextual arcs, relational arcs, and literal arcs is explained in The XDI Graph Model. In summary, XDI literal arcs are analogous to RDF arcs whose object is an RDF literal; XDI relational arcs are analogous to RDF arcs whose object is a URI; and XDI contextual arcs are analogous to RDF arcs whose object is a blank node, with a key difference being that XDI contextual arcs are uniquely addressable.

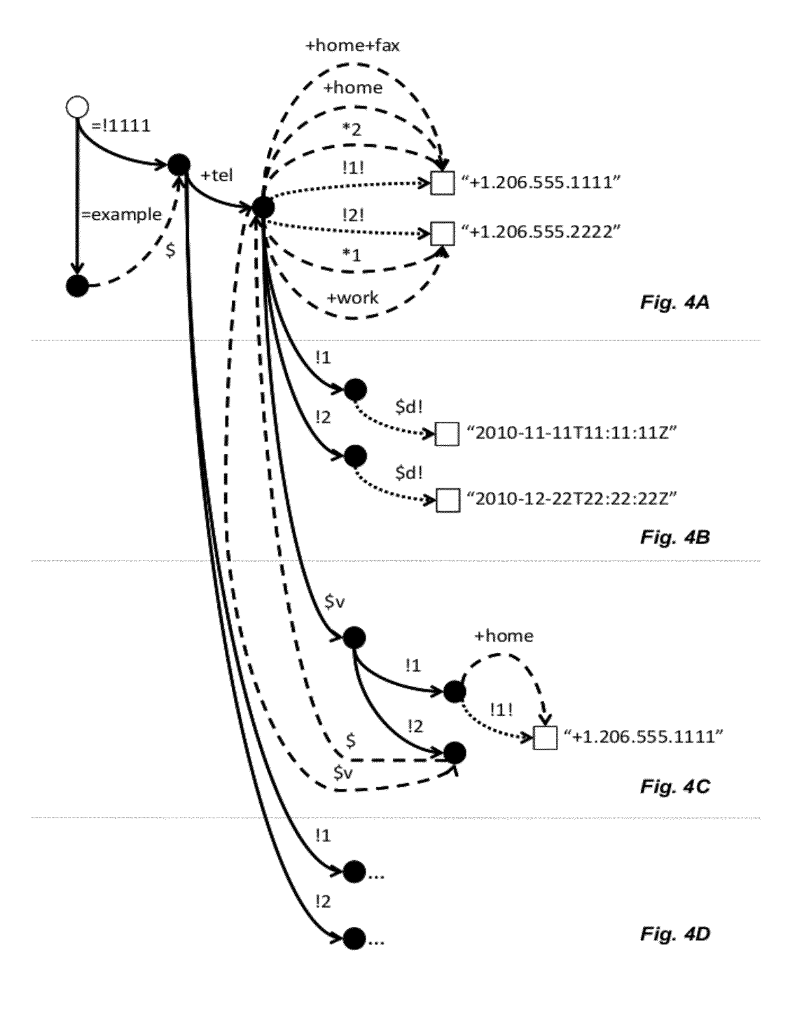

FIGS. 4A, 4B, 4C, and 4D illustrate different portions of an example XDI graph representing the digital identity of a person. Such a representation of an XDI graph in any format is called an XDI document. One of the advantages of XDI is that every node in an XDI graph is uniquely addressable using an XRI as explained in The XDI Graph Model. This is called the XDI address of the node. FIG. 4A shows the root context node of the graph as an open circle. This node has the special XDI address ( ). This special address is shared as the root node of all XDI documents and is not included in the XDI address of any node within the document. In this example there is a contextual arc labeled =!1111. This represents the root of a digital identity for a person. The = sign represents the XRI personal identifier namespace, and the ! sign represents persistent identifiers within this namespace, i.e., identifiers that are assigned once to a resource and never reassigned to another resource. In Web architecture this is referred to as a URN (Uniform Resource Name). In XRI architecture this type of identifier is referred to as an i-number. The use of persistent identifiers in digital identity systems is important from a security standpoint so that a digital identity assigned to one person is not subsequently “taken over” or “recycled” by another person. The number 1111 represent the unique i-number assigned in the =! namespace. This i-number is used for example purposes only.

Because an i-number is intended for persistence and not human-memorability, XRI architecture supports a second type of identifier called an i-name. I-names are intended to be easy for humans to recognize and remember in any language. In FIG. 4A the second arc from the root context node, labeled =example, is an example of an i-name. The context node identified by the =example arc then has a relational arc labeled $ whose object is the context node identified by the i-number =!1111. As explained in The XDI Graph Model, the relational arc $ expresses a synonym relationship, i.e., that the person identified by the i-name =example is the same person identified by the i-number =!1111. In this way the i-name =example is mapped to the i-number =!1111 to identify the persistent XDI address associated with any i-name. It is recommended that all XDI digital identities be rooted on persistent XDI addresses so links to them will not break when an i-name is changed or reassigned. This patent specification will use i-numbers for that reason. Note that XRIs in the + namespace, for generic identifiers, and the $ namespace, for special identifiers defined by the OASIS XDI Technical Committee, will use i-names because these are effectively persistent.

In FIG. 4A, three contextual arcs originate from the =!1111 context node. The first one labeled +tel identifies a context node, also called a subcontext, representing a set of telephone numbers. This is an example of a complex property as explained in The XDI Graph Model. A complex property may have multiple instances of literal values, e.g., a person may have more than one phone number. In FIG. 4A, the =!1111+tel context node has two literal arcs labeled with the i-numbers !1! and !2!. These are examples of two instances of telephone numbers. Literal arcs identify literal nodes with actual data values. The value of the !1! literal arc is +1.206.555.1111, and the value of the !2! literal arc is +1.206.555.2222. The combination of the XDI subject represented by the contextual arcs, the XDI predicate represented by the literal arc, and the XDI object represented by the data value can then be combined into a single XRI representing an XDI statement by inserting forward slashes between the subject, predicate, and object. Note that if the object is a literal value, the data is encoded first as a Data URI and then as an XRI as explained in The XDI Graph Model. The resulting XDI statements expressing these two phone numbers are given below:

=!1111+tel/!1!/(data:,+1.206.555.1111)

=!1111+tel/!2!/(data:,+1.206.555.2222)

The single character subsegment ! at the end of the XDI predicate signifies that the XDI object is a literal. This rule provides semantic precision about which XDI statements identify XDI literals.

In FIG. 4A, there are a set of relational arcs originating from the +tel node labeled *1, *2, +work, +home, and +home+fax. The *1 and *2 relational arcs provide a means of ordering the XDI literal nodes for applications that need order or priority metadata. For example, an application may need to know which is the primary telephone number and which is the secondary telephone number. The +work, +home, and +home+fax arcs provide a means of typing the XDI literal nodes so it is clear which literal node represents which type of telephone number.

FIG. 4B illustrates metadata about the telephone properties expressed in FIG. 4A. The two contextual arcs originating from the =!1111+tel context node labeled !1 and !2 identify two context nodes representing metadata about the two literal nodes with the XDI addresses =!1111/!1! and =!1111/!2!. These two context nodes have the XDI address =!1111+tel!1 and =!1111+tel!2. Each of them has a literal arc labeled $d! which identifies a datestamp. When combined with the datestamp values, this produces the following two XDI statements expressing the datestamps of the two telephone number literals given above.

=!1111+tel!1/$d!/(data:,2010-11-11T11:11:11Z)

=!1111+tel!2/$d!/(data:,2010-12-22T22:22:22Z)

FIG. 4C illustrates versioning metadata about the telephone properties expressed in FIG. 4A. The contextual arc originating from =!1111+tel labeled $v identifies the context node that serves as the root of the version subgraph. The two contextual arcs originating from =!1111+tel$v labeled !1 and !2 represent the first two versions of the =!1111+tel property. The first version has the XDI address =!1111+tel$v!1 and the second version has the address =!1111+tel$v!2. FIG. 4C shows that the first version contained only a single instance of a telephone number described by the following two XDI statements:

=!1111+tel$v!1/!1!/(data:,+1.206.555.1111)

=!1111+tel$v!1/+home/!1!

The XDI object of the second of these statements is called a local reference, since the XRI !1! is local to the same context node. Thus it serves as a pointer to the XDI literal node identified in the first statement.

The second version identified in FIG. 4C is the current version. This is indicated by a relational arc originating from =!1111+tel$v!2 labeled $ to indicate a synonym. The object is =!1111+tel, which is the current version. The identity of the current version may also be discovered from the other direction, i.e., the context node =!1111+tel has a relational arc labeled $v whose object is =!1111+tel$v!2.

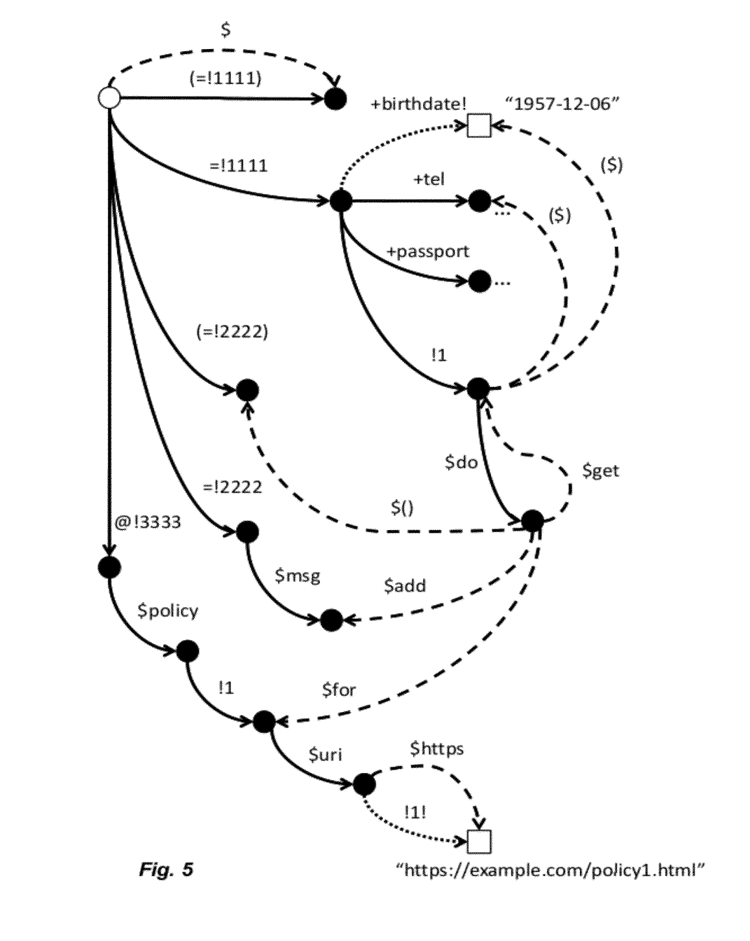

FIG. 4D illustrates two context nodes representing instances of the digital identity representing by the =!1111 context node. These are identified with the contextual arcs labeled !1 and !2 indicating that these arcs identify instances of their parent XDI subject. These nodes have the XDI addresses =!1111!1 and =!1111!2. Since their parent XDI context node represents the digital identity of a person, these nodes represent aspects of that identity known as personas. Personas may have their own properties (not shown in FIG. 4C), or they may reference properties of their parent context node (shown in FIG. 5). This enables properties to be easily shared among multiple personas, while also enabling personas to have their own persona-specific properties.

FIG. 5 illustrates an example XDI graph again showing a portion of the digital identity represented by the context node =!1111 and the persona =!1111!1 (the persona =!1111!2 is not shown in this figure). In this graph, the root context node has three additional contextual arcs labeled (=!1111), (=!2222), and =!2222. In addition it has one relational arc labeled $ whose object is (=!1111). This expresses that the root context node of this XDI graph has the XDI address (=!1111) relative to another XDI graph. Note that the address of a root context node must always be represented as an XRI cross-reference (i.e., syntactically encapsulated in parentheses) because by definition a root context node may only be addressed from another XDI context. Addressing a root context node at an XDI endpoint is done by giving it one or more URI properties as described in The XDI Graph Model.

The context node =!1111 is shown with an additional literal arc labeled +birthdate! and an additional contextual arc labeled +passport. The details of the +passport subgraph and of the +tel context node (shown in FIG. 4A) are not shown in FIG. 5. The persona =!1111!1 has two relational arcs labeled ($) whose objects are =!1111/+birthdate! and =!1111+tel. ($) is the XDI variable identifier. This means that the objects identified by a ($) relational arc are included by reference in the parent context. This is how properties may be shared across personas.

The persona =!1111!1 also has a contextual arc labeled $do. This identifies the root context node of an XDI link contract. A link contract is the graph structure used in XDI to describe authorization, i.e., the set of permissions granted by one digital identity to another to perform operations on a portion of the XDI graph. The atomic XDI operations, $get (read), $add (insert), $mod (replace), and $del (delete) and the composite XDI operations $copy and $move are explained in The XDI Graph Model. The link contract represented by the context node =!1111!1$do has four relational arcs labeled $( ), $get, $add, and $for. As explained in The XDI Graph Model, the XDI metagraph symbol ( ) is used as an XDI predicate to express the child context nodes of an XDI subject. The inverse, $( ), is used to express the parent context nodes of a XDI subject. Note that while any given context node has exactly one XDI address relative to the root context node an XDI document, that same logical context node may appear as a subgraph relative to other XDI context nodes. This is how XDI subgraphs are shared between XDI documents. This relative context relationship is expressed with the $( ) predicate. In FIG. 5, the $( ) relational arc expresses that the link contract =!1111!1$do is shared with the XDI graph at the XDI address (=!2222). This is how the set of permissions defined by the link contract are assigned to another digital identity. In this case the link contract =!1111!1$do is assigned to =!2222, the digital identity authoritative for the XDI graph at (=!2222). This means a copy of this link contract subgraph logically exists in the XDI graph whose root context node has the XDI address (=!2222). The complete XDI statement expressing this assignment is:

=!1111 !1$do/$( )/(=!2222)

The relational arc labeled $get originating from the =!1111!1$do link contract has the object =!1111!1, which means that the recipient of the link contract has permission to access the XDI subgraph rooted on the context node =!1111!1. Since in this case this includes the two relational arcs ($) explained above, that means the recipient has permission to read the birthdate and telephone number properties of =!1111, but not the passport property. The complete XDI statement expressing this permission is:

=!1111!1$do/$get/=!1111!1

Although not shown in FIG. 5, the XDI operation $copy is identical to $get in terms of providing access permission, but $copy also subscribes the recipient to all changes in the subgraph that is the object of the $copy statement. This includes $add, $mod, or $del operations. For example, if =!1111 adds a new telephone number to its =!1111+tel context, or modifies a telephone number in that context, or deletes the =!1111/+birthdate! property, or adds a new property to its =!1111!1 persona, these changes will automatically be applied to a copy of this subgraph maintained at the XDI endpoint (=!2222). This is referred to as an XDI synchronization relationship.

The relational arc labeled $add originating from the =!1111!1$do link contract has the object =!2222$msg. $msg is the special XDI identifier for XDI messages. This means the link contract grants permission for the recipient to add XDI statements to the subgraph rooted on =!2222!$msg. From an XDI perspective, this is the equivalent of a “whitelist”, i.e., a means of expressing which digital identities are permitted to send =!1111 XDI messages. The complete XDI statement expressing this permission is:

=!1111!1$do/$add/=!2222$msg

The relational arc labeled $for originating from the =!1111!1$do link contract has the object =!3333$policy!1. @!3333 is an i-number assigned in the @ namespace, the XRI global context symbol for organizational identifiers, i.e., identifiers for a legal entity other than a person. $policy is the special XDI identifier for data rights policies, also called data exchange policies, data interchange polices, or data sharing policies. A data rights policy may be any ruleset used to govern communications and data exchange relationships. A data rights policy may be expressed in either a human-readable document such as a Web page or PDF file, or in a machine-readable policy expression language such as XACML from the OASIS XACML Technical Committee. A data rights policy may also be expressed in both human-readable and machine-readable formats. A data rights policy may also be expressed in more than one human language and in more than one machine-readable policy expression language. XDI itself may be used to express a machine-readable policy expression language, though such a language has not yet been defined by the OASIS XDI Technical Committee. The particular policy expression language used is not a limiting feature of the invention. In FIG. 5, the $for relational arc means that the permissions grant by the digital identity =!1111 to the recipient =!2222 under the link contract =!1111!1$do are subject to the policy @!3333$policy!1. The complete XDI statement expressing this policy association is:

=!1111 !1$do/$for/@!3333$policy!1

In the example XDI graph illustrated in FIG. 5, @!3333$policy!1 serves as the persistent logical XRI identifier of the policy, which then may have multiple representations as described above. FIG. 5 shows only one representation, as an HTML document available via the HTTPS protocol at the URI “https://example.com/policy1.html”. This is expressed by the context node @!3333$policy!1 having the contextual arc labeled $uri to identify the set of URIs that are properties of this policy. The context node @!3333$policy!1$uri then has a relational arc labeled $https whose object is the literal node identified by the literal arc labeled !1!. This literal object contains the URI data in a string format. The complete XDI statement expressing this policy location is:

@!3333$policy!1$uri/!1!/(data:, https://example.com/policy1.html)

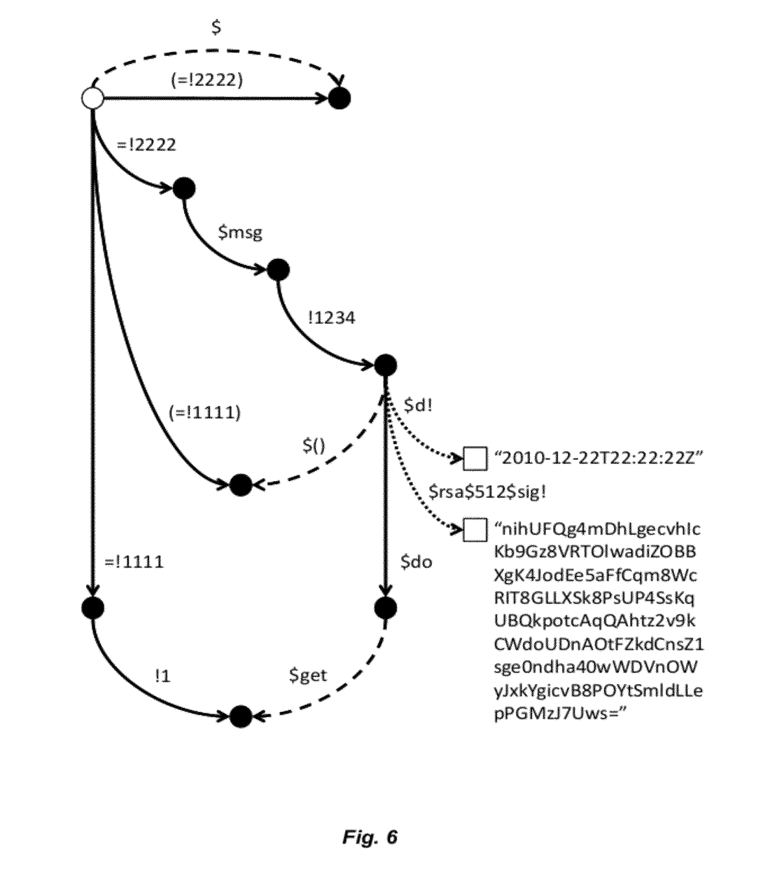

FIG. 6 illustrates an example XDI graph showing an XDI message that would be sent from digital identity =!2222 to digital identity =!1111 under the terms of the link contract illustrated in FIG. 5. The originating XDI endpoint is expressed by the relational arc on the root context node labeled $ whose object is (=!2222). The originating sender is the digital identity identified by the contextual arc =!2222. The context node =!2222 has the contextual arc $msg to identify the context node =!2222$msg containing XDI messages. The context node =!2222$msg has the contextual arc !1234 to identify a specific instance of a message. The context node =!2222$msg!1234 has four arcs: a literal arc $d! for a datestamp on the message, a literal arc $rsa$512$sig! for a digital signature on the message, a relational arc $( ) to identify the recipient(s) of the message, and a contextual arc $do to identify the XDI operation(s) the message will request. In this example there is only one recipient, (=!1111), and only one operation requested, which is a $get operation on the subgraph rooted on the XDI address =!1111!1.

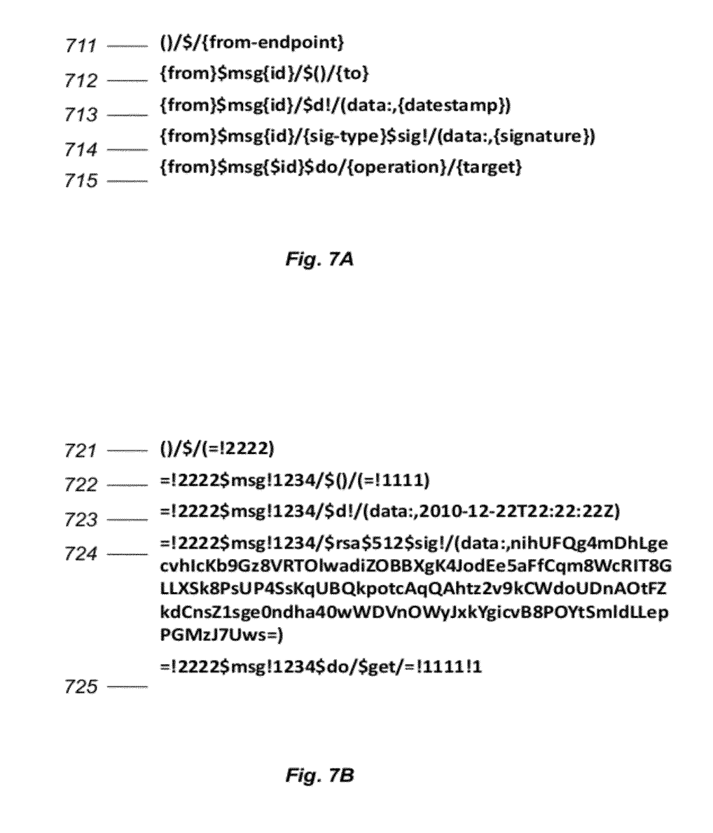

FIG. 7A illustrates the template for a signed XDI message in XDI statement format as explained in The XDI Graph Model. Each character string in squiggly brackets, e.g., {from}, indicates a variable in the template. The {from-endpoint} variable represents the XDI endpoint from which the message originates. This statement is optional if the message is sent from the default XDI endpoint for the sender, i.e., if the {from-endpoint} variable is simply an XRI cross-reference to the sender's XRI. The {from} variable is the XRI for the digital identity that is the sender of the message. The {id} variable is the i-number assigned to uniquely identify the message in the sender's XDI message context. The {to} variable is the XRI of the XDI endpoint that is the destination of the message, also called the target context. The {datestamp} variable is the datestamp of the message in XML datetime format. The {sig-type} variable is the XRI representing the type of digital signature algorithm used to sign the message. The {signature} variable is the value of the digital signature on the message. The {operation} variable is the XDI operation being requested by the message. The {target} variable is either the XDI address or the XDI statement on which the operation is requested. $get and $del operations operate against XDI addresses, i.e., context nodes or literal nodes in the graph. $add and $mod operations operate against XDI statements that are either being added (inserted) or modified (replaced) in the graph.

In FIG. 7A, line 711 expresses the XDI address of the XDI endpoint from which the message originates. Line 712 expresses the XDI address of the sender, the message ID, and the XDI address of the target context. Line 713 expresses the datestamp of the message. Line 714 expresses the type and value of the digital signature on the message. Digital signature types are defined in the $ namespace by the OASIS XDI Technical Committee. An example is $rsa$512 expressing the RSA digital signature algorithm using a 512 byte key size. Line 715 expresses the XDI operation requested by the message. Multiple XDI operations may be requested in a single message by including multiple instances of the template in line 715.

As explained in The XDI Graph Model and associated XDI Technical Committee documents, a digital signature is applied to the JSON serialization of the message by applying the following steps: a) ordering all XDI statements in the message exclusive of the digital signature statement in ASCII order, b) performing the JSON serialization without adding any insignificant whitespace, c) calculating the digital signature over the JSON object, and d) appending the XDI statement containing the digital signature value to the JSON serialization. This algorithm has the advantages of very simple and fast canonicalization, so it is less prone to error or misinterpretation that XML dSig or other digital signature formats. However the specific digital signature format is not a limiting feature of the invention.

FIG. 7B illustrates the example XDI message in FIG. 6 in XDI statement format following the template in FIG. 7A. Line 721 of the message corresponds to line 711 of the template; line 722 to line 712; line 723 to line 713; line 724 to line 714; and line 725 to line 715.

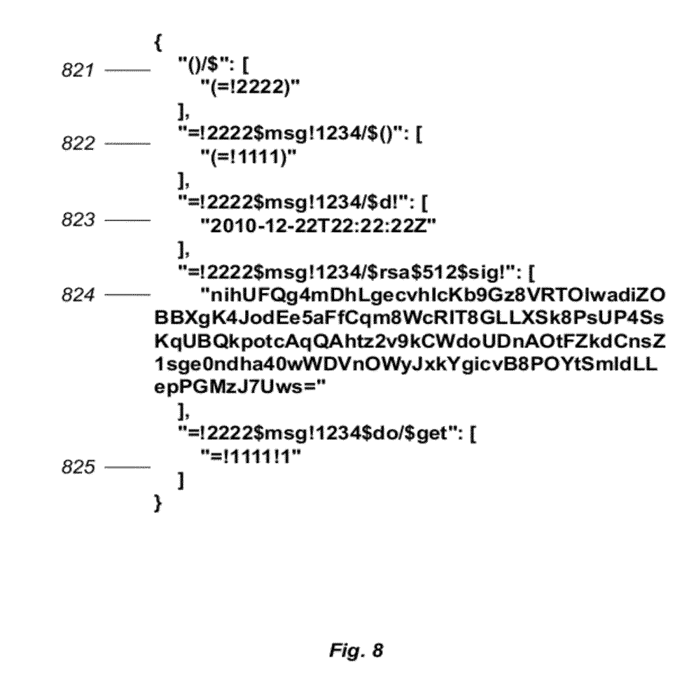

FIG. 8 illustrates the JSON serialization of the XDI message in FIG. 7B. Line 821 of the message corresponds to line 721 of the template; line 822 to line 722; line 823 to line 723; line 824 to line 724; and line 825 to line 725. As explained in The XDI Graph Model, the JSON serialization format is very simple. The XDI graph is serialized in a single JSON object where each XDI statement is one key:value pair. The key is the first two segments of the XDI statement, without a trailing forward slash. The value is a JSON array. The value(s) within this JSON array are interpreted as follows: a) the value is a literal JSON data format if the predicate of the XDI statement consists of multiple subsegments and the final subsegment consists of only the ! character (signifying an XDI literal arc), b) the value is an XRI if the predicate of the XDI statement is not a literal arc and the array value is a JSON string, and c) a recursive subgraph of XDI statements is if the predicate of the XDI statement is not a literal arc and the array value is a JSON object. This last option enables efficient serialization of XDI subgraphs that are the target of XDI $add and $mod operations.

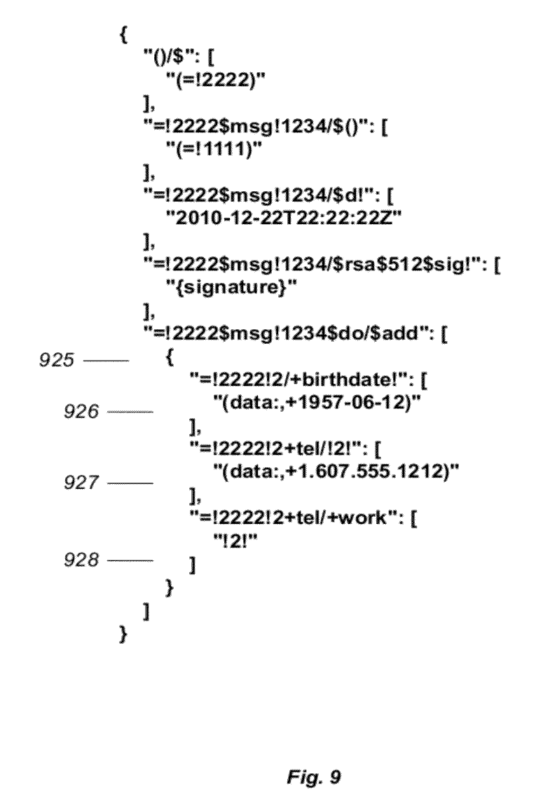

FIG. 9 illustrates the JSON serialization of an XDI message with a $add operation. The first four XDI statements are the same as FIG. 8 (except for the signature value, which is elided for clarity). The operation statement 925 is a $add operation. Since a $add operation operates on a subgraph of XDI statements, the value in the JSON array is a JSON object which recourses the XDI serialization format. The first statement in the subgraph, statement 926, expresses a birthdate literal value to add to the persona !2 of the digital identity =!2222. Statement 927 expresses a telephone number to add, and statement 928 expresses the type of this telephone number using a local reference.

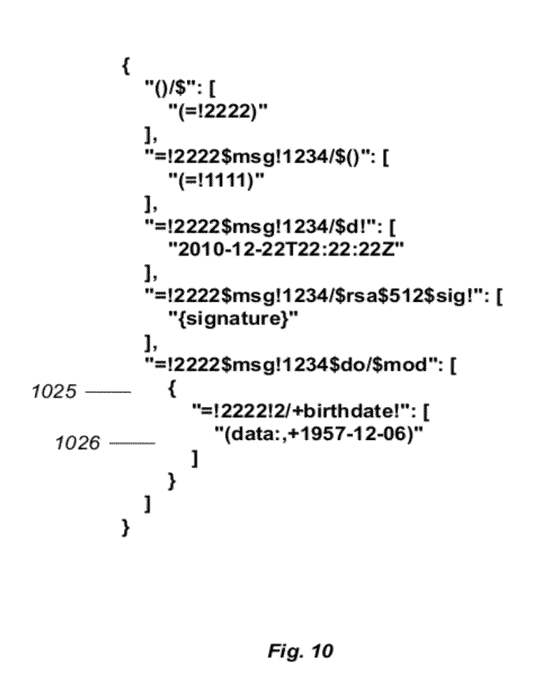

FIG. 10 illustrates the JSON serialization of an XDI message with a $mod operation. Again the first four XDI statement are identical to FIG. 9. The operation statement 1025 is a $mod operation which, like a $add operation, operates on a subgraph of XDI statements. In this example there is just one statement 1026, which will modify the value of the birthdate literal value added using statement 926 in FIG. 9.

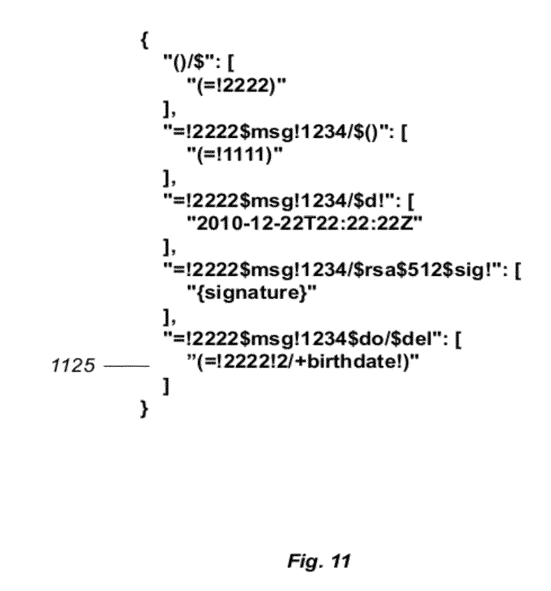

FIG. 11 illustrates the JSON serialization of an XDI message with a $del operation. Again the first four XDI statement are identical to FIG. 10. The operation statement 1125 is a $del operation which, like a $get operation, operates on a set of XDI addresses. In this example there is just object in statement 1125, which is the birthdate literal node added using statement 926 in FIG. 9 and modified using statement 1026 in FIG. 10. Statement 1125 would result in this literal node being deleted from the =!2222!2 context node.

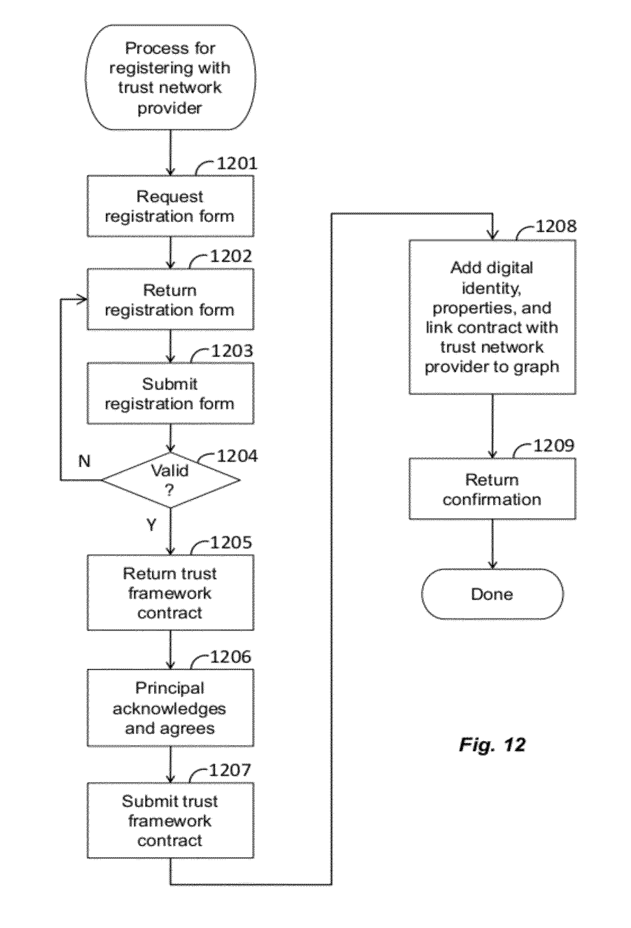

FIG. 12 illustrates an example method for joining a trust network. Using this method, the people or organizations represented by digital identities, referred to as principals, enter into a membership relationship with the legal entity operating the trust network, called the trust network provider. This relationship conveys certain rights and benefits to the principals and also entails certain responsibilities and duties for the principals. Therefore it is both a legal and a technical relationship, and it is embodied as both a legal contract and a link contract in the process illustrated in FIG. 12.

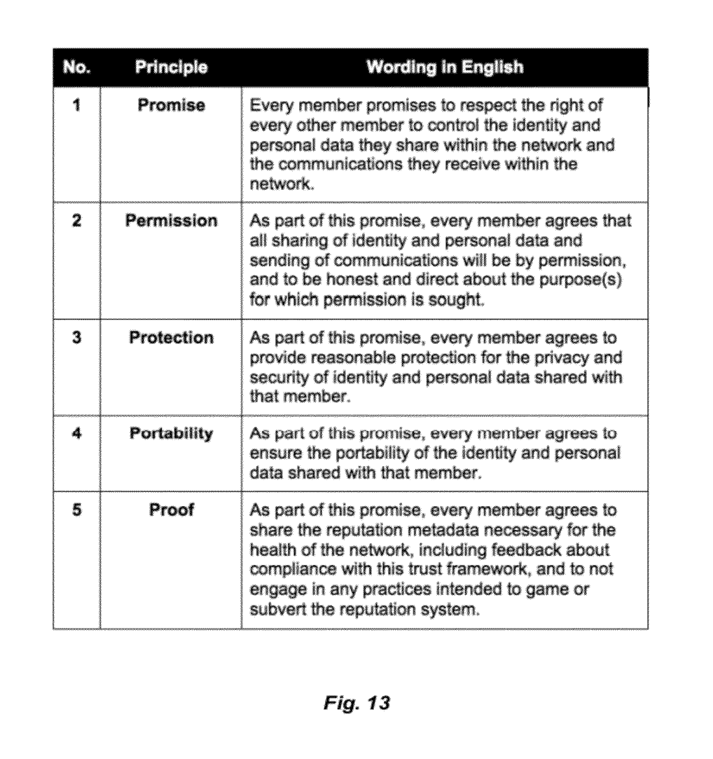

For simplicity the process will first be illustrated using the dumb client architecture illustrated in FIG. 1. In step 1201 the principal uses browser 111 on dumb client 110 to request a registration form as a web page 121 from server 120 operated by the trust network provider. In step 1202 server 120 returns the registration form 121 to the browser 111. This form asks the principal for the registration information required under the terms of service with the trust network provider. In an embodiment, this includes the principal's display name, desired i-name (to serve as a username), legal jurisdiction, and an authentication credential such as a password. Other embodiments may include other registration information. In step 1203 the principal submits the registration form 212 to server 120. In step 1204 the server engine 125 processes the submitted registration data to check for validity and uniqueness in the case of the desired i-name. If not valid, step 1202 is repeated. If it is valid, step 1205 returns a human-friendly form of the trust framework contract, a partial example of which is shown in FIG. 13. The trust framework contract is further discussed below. For legal enforceability, in step 1206 the principal is required to acknowledge agreement to the trust framework contract in a manner that is considered legally enforceable in the legal jurisdiction submitted on the registration form. For example, in some jurisdictions the principal may check a checkbox in the HTML form signifying that the principal has read and agreed to the terms of the trust framework contract. Other steps may be required in other jurisdictions. Proper execution of this step is important so that the principal is legally bound by the trust framework contract. In step 1207 the principal submits the trust framework contract to server 120. In step 1208 the server engine 125 proceeds to add the registration data to the logical graph maintained by the trust network provider. In the embodiment of the registration form discussed above, this includes adding: a) the i-number representing the digital identity of the principal, b) the i-name selected by the principal, c) the synonym relation between the i-name and the i-number, d) a $( ) relation to a context node identifying the legal jurisdiction of the principal, and e) a link contract embodying the relationship between the principal and the trust network provider established by the trust framework contract. This link contract gives the trust network provider the permissions with regard to the principal's graph necessary to perform the trust network provider's duties under the trust framework contract. The link contract also includes a $for relation to the context node defined by the trust network provider to logically identifying the trust framework contract. This $for relation is illustrated in FIG. 5 and explained above. This $for relation is the technical representation of the principal's agreement to the trust framework contract, and when added to the logical graph by the trust network provider represents activation of the principal's membership in the trust network.

FIG. 13 illustrates an example of a portion of a trust framework contract. This example reflects five principles that are the basis for a particular trust framework contract called the Respect Trust Framework™, a trademark of Respect Network Corporation dba Connect.Me™. Of these five principles the first one, Promise, illustrates a particular embodiment of the present invention. It represents a promise of reciprocity in identity and data rights, i.e., it applies the “golden rule” to the control of identity and data in a trust network. When such an ethical and legal rule is bound to the technical capability of a trust network to provide one or more enforcement mechanisms for this rule, it produces a set of incentives for cooperation, reciprocal trust, and mutual respect that increases the value of membership in the trust network for every member. Such a trust network is then subject to the network effect whereby each additional member who joins the network and agrees to the trust framework contract makes the network still more valuable, attracting yet more members. This “virtuous circle” or “race to the top” incents continued positive behavior across the membership as the network grows. Furthermore, if the enforcement mechanisms are other self-reinforcing actions of the members, it produces a self-regulatory system for protection of online privacy and data rights that is faster, more efficient, more flexible, and less costly than external legal legislation or regulation.

This innovation can also be understood from the standpoint of economic signaling theory and in particular contract theory, which is the study of how economic actors construct contractual arrangements, especially in the presence of asymmetric information. In the case of a trust network, the asymmetric information is that a first party to a potential relationship may have the knowledge that they are highly trusted by other members of the network, but this knowledge is not readily available to a second party. By giving the first party a means to send an honest signal to the second party about the level of trust in the first party, this asymmetry can be overcome, and the two parties can benefit from forming a relationship. This is particularly valuable in online interactions taking place over global networks like the Internet, where many potential relationships are lacking in most if not all of the conventional signals of trust that are present in most real-world interactions.

The act of entering into a contractual commitment with a trust network provider to operate according to the rules of a trust framework contract that includes a promise of reciprocal respect for data rights, when publicly verified and published by the trust network provider, sends a strong first signal to potential relationship partners. The effective strength of this signal is increased with each additional commitment to positive data practices that are incorporated into the trust framework contract. For example, the second and third principles listed in FIG. 13, called Permission and Protection, reflect operational definitions of some of the best known Fair Information Practices Principles (FIPPs) such as those published by the U.S. Federal Trade Commission, the European Union Data Protection Directive, the Organization for Economic Cooperation and Development (OECD), and others. The fourth principle, Portability, reflects the significantly increased value of personal data to an individual (and in some cases to a website or service provider holding the data) if that data is portable from one website to another, or one service provider to another. An example of the value of such portability was when the United States mandated the portability of mobile telephone numbers in 2003. Although opposed by mobile carriers for some time, it was later acknowledged as a significant boon to the growth of mobile phone services in the United States. The move to support personal data portability on the Internet is supported by many organizations such as the Data Portability Project and the Center for Democracy and Technology. The Portability principle has even greater utility and value when applied to the right of a trust network member to switch between data service providers as further described below. The fifth principle, Proof, represents an additional commitment to a reputation system as an enforcement mechanism for compliance with the trust framework contract. This reputation system is further discussed below. When the combination of these principles are incorporated into the trust framework contract, the strength of the resulting signal issued when a principal enters into the contract is heightened, providing both immediate and long-term value for each new member who enters into the contract. One additional advantage of such a trust framework contract is that it does not require an economic exchange to be enforceable. Rather it is enforceable because it is a mutual exchange of promises. This enables the trust network based on such a contract to grow quickly and scale to Internet size with very little friction, in the same manner as a social network like Facebook or Twitter where there is no cost for the social networking service to members. Unlike these social networks, however, these benefits do not come at the expense of privacy or data control. Members of a trust network employing the trust framework contract model describe herein still enjoy the protections and incentives for positive behavior of the reciprocal promise embodied in the trust framework contract.

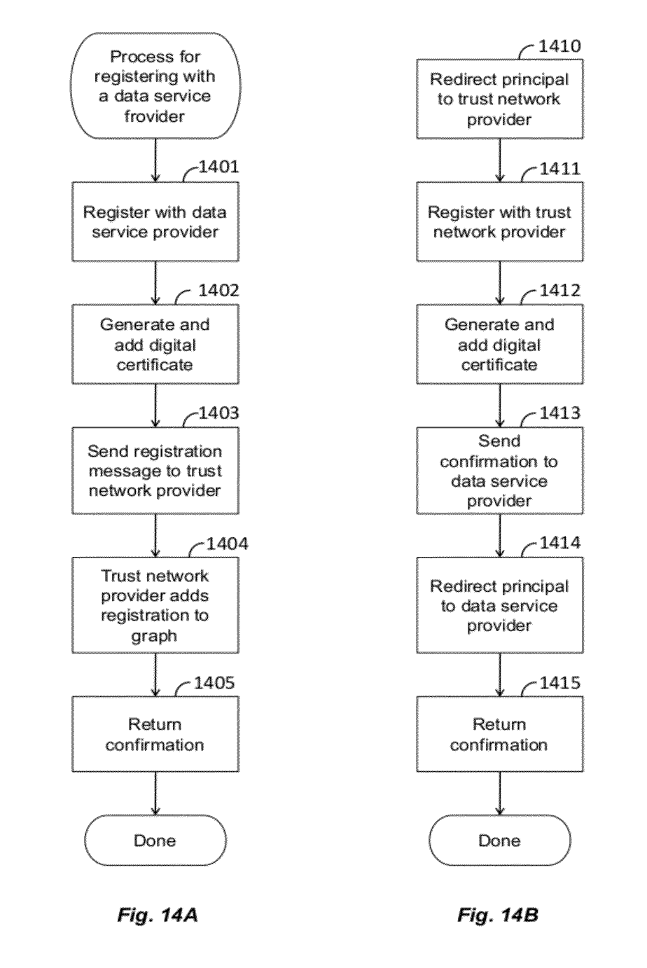

FIG. 14A illustrates an example method for joining a trust network using multiple data service providers. This is a desirable feature of a trust network because virtually all large-scale trust networks are multi-provider systems with competitive markets. Examples include the international banking network, the telephone network, credit card networks, ATM networks, and the Internet Domain Name System (DNS). Each of these markets depends on the establishment of standard contract terms to assure that participants act in reliable and predictable ways. To support a multi-provider system that enables a competitive market for personal data services, the trust network provider may contract with any number of data service providers to whom the trust network provider delegates the ability to register members of the trust network. In this embodiment, both the trust network provider and the data service providers each operating one or more servers 120 as shown in FIG. 1. In a further embodiment, the contract between the trust network provider and the data service providers is identical to or incorporates the trust framework contract. This binds the data service providers to the same reciprocal respect and trust principles described above, maximizing trust throughout the network. In a further embodiment, the execution of this trust framework contract is reflected as a link contract between the trust network provider and the data service provider in the logical graph the same way the principal's trust framework contract is reflected in the process described for FIG. 12.

In FIG. 14A, in step 1401 the principal registers with the server 120 (FIG. 1) of the data service provider in the same manner as the process described in FIG. 12. Once this process is complete, in step 1402 the data service provider uses crypto engine 126 (FIG. 1) to generate a public/private key pair and a digital certificate for the principal and adds this to the principal's graph. In step 1403 the data service provider sends an XDI message to the trust network provider to perform the registration at the trust network level. In step 1404 the trust network provider adds the registration information, including the digital certificate, to the trust network graph maintained by the trust network provider. To ensure portability of the principal's registration across data service providers, the trust network provider registration data includes the same data gathered in the process described in FIG. 12. If the data service provider operates a special server 120 or farm of servers 120 (FIG. 1) to serve the principal, the information will also include the URI of the principal's XDI endpoint at that server or server farm so the principal can receive XDI messages at that URI. In addition, it includes a copy of the link contract between the principal and the data service provider.

FIG. 14B illustrates an extension of the method in FIG. 14A to provide additional registration protection. In the method of FIG. 14A, the data service provider is fully entrusted by the principal to safeguard the principal's graph and carry out actions on the trust network on the principal's behalf Given the trust framework contract described above and the incentives for reciprocity of trust it creates, this may be sufficient incentive to effectively prevent malicious actions on the part of the data service provider. However there is always the possibility of an “insider attack” from a disgruntled employee or other agent of the data service provider, who with sufficient access to the data service provider's logical graph could impersonate the principal if to the principal's public/private key pair or other authentication and authorization credentials are stored in database 122 (FIG. 1) or are otherwise accessible to the data service provider without the principal's approval. One approach to prevent this form of attack is for the principal to register a separate set of authentication and authentication credentials directly with the trust network provider. A method for accomplishing this that augments the registration process in FIG. 14A is shown in FIG. 14B. In this method the registration process is not completed in step 1405 of FIG. 14A, but is followed by step 1410 of FIG. 14B. In step 1410 the data service provider redirects principal's browser 111 to the server 120 operated by the trust network provider. In step 1411 the principal registers the information needed to be able to separately authenticate directly to the trust network provider as described in the method of FIG. 12. In step 1412 the trust network provider generates key material and a digital certificate in the same manner as the data service provider in step 1402 of FIG. 14A and adds this to the principal's digital identity in the trust network provider's graph. In step 1413 the trust network provider sends a confirmation message to the data service provider to signal completion of the principal's registration. In step 1414 the trust network provider redirects the principal's browser 111 to the data service provider's server 120. In step 1415 the data service provider returns a final confirmation of registration to the principal.

The method of FIG. 14B provides additional security by forming separate trust relationships between the principal and data service provider and between the principal and the trust network provider. However it still exposes the principal to the risk that the data service provider and trust network provider may collude, or that the server 120 operated by either of them could be compromised. For additional security and convenience, the principal may register a smart client 210 (FIG. 2) with the trust network.

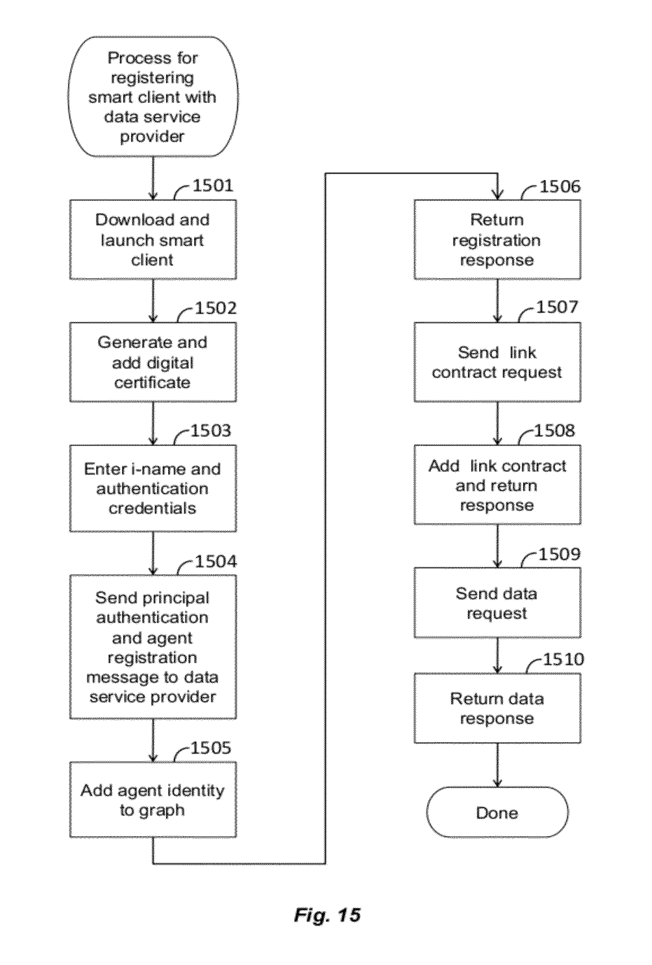

FIG. 15 illustrates a method for registering a smart client with the trust network. This registration may be either directly with the trust network provider or with a data service provider. For convenience this description will assume a data service provider. This method may be used with any client device with the necessary hardware and software. Such a device may come pre-loaded with the necessary software. If not, in step 1501, the principal downloads and launches the necessary smart client 210 (FIG. 2) from a trusted source. In an embodiment smart client 210 maintains a local copy of a portion of the principal's graph in database 212 (FIG. 2). In step 1502, the smart client 210 uses crypto module 216 (FIG. 2) to generate a public/private key pair and a digital certificate and adds them to the graph. In step 1503 smart client 210 prompts the principal for the i-name and authentication credentials registered with the data service provider in FIGS. 14A and 14B. In step 1504 smart client 210 sends an XDI message to the server 120 (FIG. 2) of the data service provider using this identifier and authentication credential to authenticate the principal to the data service provider. This message also includes registration information generated by smart client 210 to uniquely identify its own digital identity as an agent operating on the principal's behalf. This may include any identifier and credential suitable for this purpose. In one embodiment, this identifier is a UUID as defined by the Open Software Foundation (OSF) as part of the Distributed Computing Environment (CDE). In another embodiment the smart client 210 registers a local i-number registered within the XRI namespace assigned to the digital identity of the principal in the methods of FIG. 12 or FIGS. 14A and 14B. For example if the principal's globally unique i-number is =!1111, the subcontext assigned to smart clients is +agent, and the local i-number assigned within that namespace to smart client 210 is !1, the smart client 210 will have the agent identity XRI =!1111+agent!1. Unlike a UUID, this identifier is discoverable and resolvable and can now serve as a specific communication endpoint within the principal's graph. In an embodiment the authentication credential for smart client 210 is its own digital certificate generated by crypto module 216 (FIG. 2). This has the advantage of enabling smart client 210 to send signed XDI messages that can be verified by the data service provider. However any other suitable authentication credential may be used. The identifier and authentication credential used by smart client 210 are not a limiting feature of the invention. In step 1505, the data service provider adds the agent identity information to the principal's graph stored in database 122 (FIG. 2). In step 1506 the data service provider returns a response to the agent registration message. This completes registration of smart client 210 as an agent for the principal. Steps 1507-1510 are optional additional steps to further configure smart client 210. In step 1507 smart client 210 sends an XDI message with a link contract request to server 120 at the data service provider. This link contract specifies the data in the principal's graph that the principal wishes to have synchronized with the data service provider. In step 1508 the data service provider adds this link contract to the principal's graph and returns an acknowledgement. In step 1509 smart client 210 sends an XDI message to server 120 requesting the data to be copied, i.e., initiating the XDI synchronization relationship. In step 1510 the server responds with the data which smart client 210 adds to database 212 to complete the synchronization. The capability of the principal to easily and quickly set up an automated synchronization relationship on any desired smart client 210 of any desired data in the principal's graph, including data shared by other members of the network such as contact data, is especially beneficial when such sharing relationships are covered by the trust framework contract described above.

As described above, the fifth principle of the trust framework contract illustrated in FIG. 13, Proof, refers to inclusion of a reputation system as an enforcement mechanism for the promise each member makes in agreeing to the trust framework contract. One skilled in the art will recognize that many reputation systems could be used for this purpose. In an embodiment of the present invention, a peer-to-peer reputation system is used to take advantage of the reciprocal trust relationship incentives created by the trust framework contract design. In this embodiment members of the trust network send signals of positive reputation to other members. These signals are called vouches. In another embodiment members of the trust network send signals of negative reputation to other members. These signals are called complaints. In other reputation systems these signals of positive and negative reputation may have other names; the names used for these signals is not a limiting feature of the invention. In an embodiment the trust network provider maintains the graph of vouches and complaints pertaining to each member on one or more servers 120 (FIG. 1). This subset of the overall logical graph is called the logical reputation graph or just reputation graph. In another embodiment the logical reputation graph is maintained cooperatively using XDI synchronization or another similar synchronization method among the servers 120 operated by both the trust network provider and data service providers. In yet another embodiment the logical reputation graph is maintained on a peer-to-peer basis among all smart clients 210 and servers 220. The configuration of clients and servers for maintenance of the logical reputation graph is not a limiting feature of the invention. To simplify the descriptions below, the system actor performing processing of XDI operations in order to effect changes to the logical reputation graph is referred to as the agent regardless of whether that role is played by a server 120 operated by the trust network provider, a server 120 operated by a data service provider, or by a smart client 210.

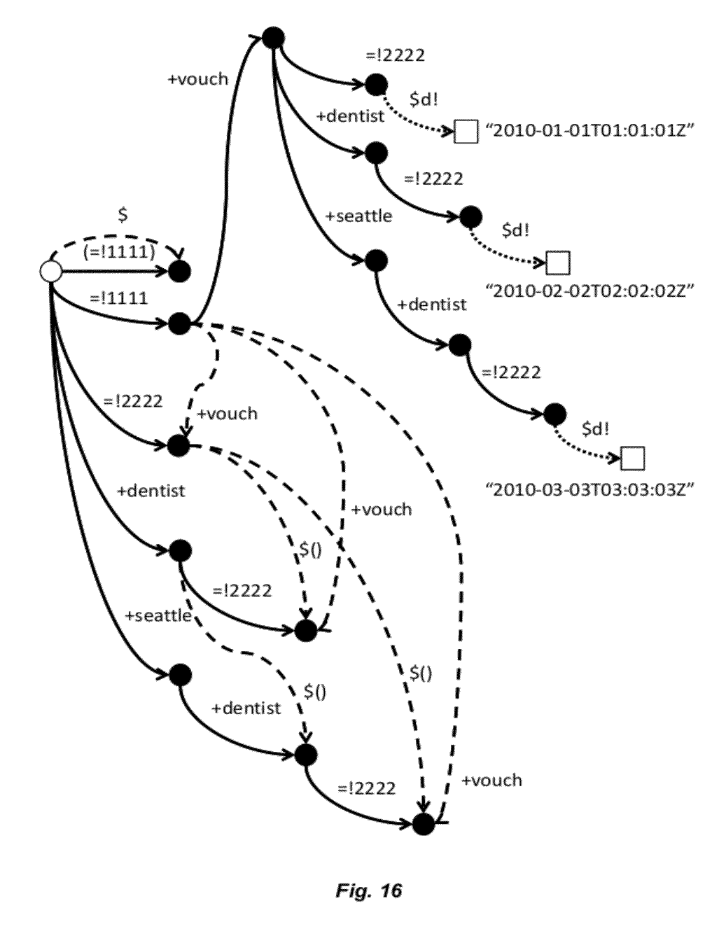

FIG. 16 illustrates an example XDI graph representing vouching relationships. The root context node has a literal arc $ indicating a synonym relationship to the context node (=!1111), indicating the XDI authority for this XDI document is the digital identity =!1111. The graph also displays a context node =!2222. This represents another digital identity in the XRI personal namespace, typically a person, with whom =!1111 has some form of relationship. The specific form of relationship is represented by one or more relational arcs from =!1111 as the subject to =!2222 as the object. The XDI Graph Model and other XDI Technical Committee public documents have examples of such relationships such as the symmetric +friend and asymmetric +follower relationships used in social graphs. Other natural language descriptors for relationship identifiers may easily be adapted to XRIs such as +teammate, +roommate, +mother, and +brother. These relationship identifiers may also be contextualized, for example +soccer+teammate and +seattle+soccer+teammate. The example XDI graph in FIG. 16 illustrates vouching relationships as relational arcs labeled +vouch. The digital identity represented by the context node originating the +vouch relation is called the voucher and the digital identity represented by the context node that is the target of the relation is called the recipient. Three vouching relationships are shown: one directly from =!1111 to =!2222, one from =!1111 to =!2222 in a +dentist context, and one from =!1111 to =!2222 in a +seattle+dentist context. The XDI statements expressing these three relationships are:

=!1111/+vouch/=!2222

=!1111/+vouch/+dentist=!2222

=!1111/+vouch/+seattle+dentist=!2222

This illustrates a particular advantage of vouching using a contextual graph model: vouches can be restricted to a particular context. It is an adage in reputation systems that “trust is contextual”, i.e, the person you trust to be your dentist you may not trust to be your car mechanic or your travel agent and vice versa. A graph model that enables digital identities to be represented in context and enables relationships to be represented relative to those contexts enables contextual vouching. Contextual vouching has the benefit that the signal sent by a vouch in a particular context carries greater meaning and value by virtue of that restriction. For example, “I trust Jack as a dentist” is more useful and actionable to a friend who may be looking for a dentist than the more general statement, “I trust Jack.” Similarly, “I trust Jack as my Seattle dentist” is even more useful if the friend is looking for a dentist in Seattle, and can be more quickly ignored if the friend is looking for a dentist in another city. FIG. 16 also illustrates how relationships are discoverable across the graph. For example, using an appropriate user interface, the principal with digital identity =!1111 can discover that the digital identity =!2222 is also represented in the +dentist and +seattle dentist contexts as indicated by the relational arcs labeled $( ), and that the +dentist context is also represented in the +seattle context by virtue of another relational arc $( ). Lastly, FIG. 16 also illustrates that principal =!1111 can maintain any desired metadata about these vouching relationships in the principal's own context, where the principal has full authority. This is accomplished using the standard XDI graph pattern of “reifying” a relationship identified by a relational arc into a context identified by a contextual arc. In this case the vouching relationships formed by =!1111 are reified by the contextual arc labeled +vouch. Each object of a +vouch relational arc is then identified by a subgraph of the =!1111+vouch context. Metadata may now be added within these subgraphs as necessary. For example, FIG. 16 shows three datestamps identified by literal arcs $d! identifying the date and time each of the three +vouch relationships were created.

Although FIG. 16 illustrates positive reputation relationships as binary values represented by a relational arc labeled +vouch, in another embodiment a positive reputation value may be represented as a scalar value, a ranking value, or any other quantifiable measurement. For example, if a five-star scalar system was used, where one star represented the least positive and five stars the most positive reputation, and a +vouch relational arc could be extended by the star rating value. For example, a 4 star vouch in the +dentist context would be expressed with the XDI statement:

=!1111/+vouch*4/+dentist=!2222

In an embodiment a scalar measurement system is used where 0.0 represents neutral reputation and 1.0 represents maximum positive reputation. Using this form of reputation scale, the preceding example would be expressed as:

=!1111/+vouch+0.8/+dentist=!2222

In another embodiment expressions of positive and negative reputation are combined into a single relational arc type. An example is a relational arc labeled +reputation that is extended using an XRI cross-reference with a scalar value between −1.0 and +1.0. Using this technique, the preceding example would be expressed:

=!1111/+reputation(+0.8)/+dentist=!2222

To express negative reputation a negative number is used. For example, a mild negative reputation for the above dentist would be expressed:

=!1111/+reputation(−0.3)/+dentist=!2222

Alternatively negative reputation statements can be expressed using an XRI specifically for negative reputation, such as +complaint. These embodiments illustrate that both positive and negative reputation statements together with any form of metadata about such statements may be asserted in the logical graph using relational arcs labeled with a suitable reputation vocabulary. The particular reputation scale or vocabulary is not a limiting feature of the invention.

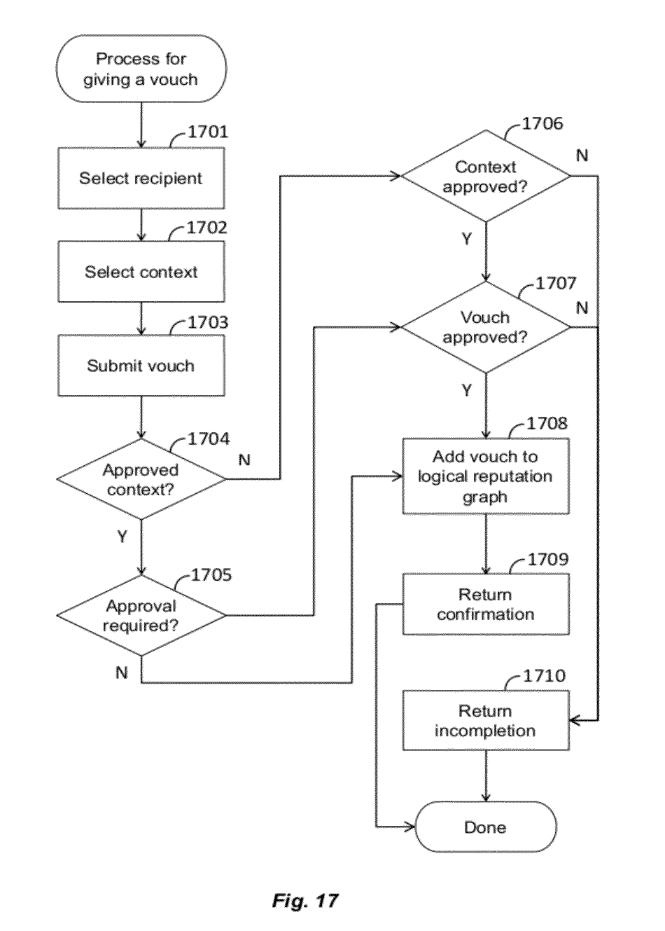

FIG. 17 illustrates an example method for giving a vouch. The ability to give and receive vouches as a signal of positive reputation is of special advantage in a reciprocal trust network because it is a second explicit signal of trust. Unlike the first signal of accepting the trust framework contract and link contract, which is a signal given to all members of the network (and to outside observers who are able to view and verify the membership), the second signal given by a vouch is: a) specific to the relationship between two members, so it has particular value to both members, and b) specific to a context, so it may have even greater value due to its relationship with that context as explained above.

In step 1701 of FIG. 17, the voucher selects the recipient of the vouch. This step may be implemented in a manner appropriate to the context of the user interaction. For example, the voucher may select the recipient from a general directory of trust network members; from a context-specific directory or address book of members; from the principal's local directory or address book of members in the principal's own graph; from a message introducing or recommending another member; from a widget on a web page; from an email message; etc. The method of recipient selection is not a limiting feature of the invention. In step 1702 the voucher selects the context for the vouch. Again, this step may be implemented in different ways appropriate to the user's application and context. For example, a directory or address book may show a partial or complete set of contexts for which a recipient has already been vouched, or has approved for vouching. An autosuggest feature may provide a picklist of contexts and subcontexts. Interactions in a specific context, such as a job board, may suggest subcontexts appropriate to that context. The method of context selection is not a limiting feature of the invention. In step 1703 the voucher submits the vouch. In an alternate embodiment steps 1701, 1702, and 1703 are combined into a single action in which a voucher may vouch for a specific recipient in a specific context with a single action.

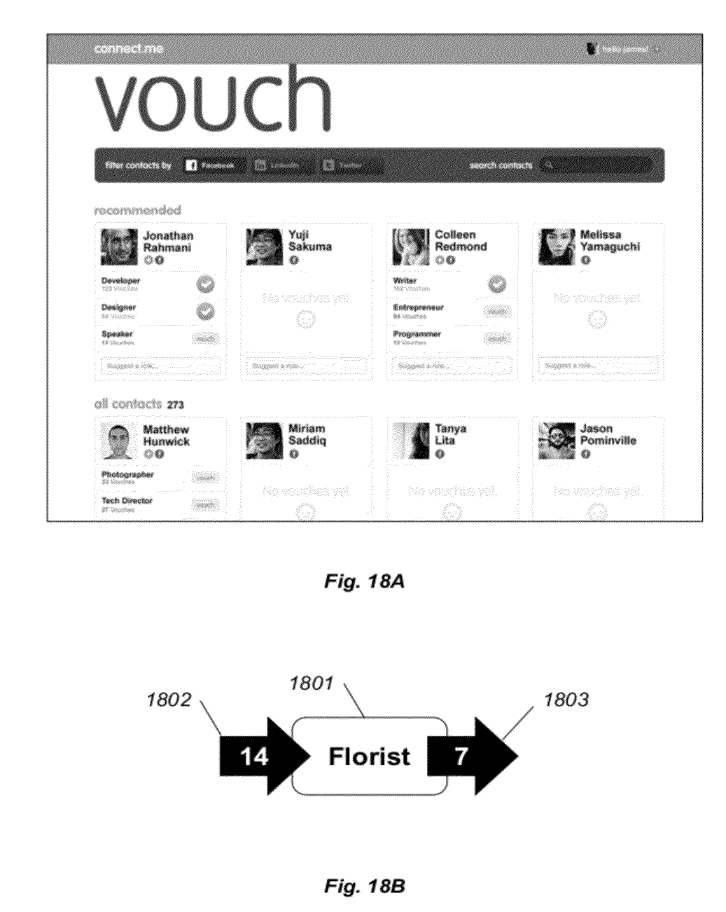

FIG. 18A illustrates an example of a user interface displaying a vouch button to perform this single vouching action. Processing of this action depends on the configuration of the trust network and the agent being interacted with to maintain the logical reputation graph as described above. For example, if this action is performed using dumb client 110 (FIG. 1) communicating with server 120 (FIG. 1) operated by the trust network provider, the resulting operations will be internal to the logical reputation graph maintained by the trust network provider. If this action is performed using dumb client 110 communicating with server 120 operated by a data service provider, it will result in processing at the data service provider and in one or more XDI messages to coordinate with the trust network provider to maintain the logical reputation graph. If this action is performed using smart client 210 (FIG. 2) registered with a data service provider, the vouch is first added to the local graph in database 212 and then an XDI message communicates this addition to the server 120 operated by the data service provider to maintain the logical reputation graph, which then coordinates with the server 120 operated by the trust network provider. If this action is performed using smart client 210 (FIG. 2) communicating on a peer-to-peer basis with other smart clients 210 or servers 120, XDI messages are sent as needed to maintain the logical reputation graph.

In step 1704 of FIG. 17, if desired to protect privacy in a manner consistent with the trust framework contract, the agent processing the message determines if the context is an approved context for the recipient. In the case of the trust network provider maintaining the logical reputation graph, this is accomplished by sending an XDI $get message to server 120 (FIG. 1) operated by the trust network provider to see if the recipient's digital identity appears in that context. If yes, processing proceeds to step 1705. If not, the recipient's permission must be obtained in step 1706 before adding the context. In step 1706, if the recipient is registered directly with the trust network provider or with the same data service provider as the voucher, the trust network provider or data service provider may notify the recipient according the recipient's preferences to make this decision. Otherwise an XDI message is sent to the recipient's XDI endpoint to request approval. Again this message is processed according to the recipient's preferences. If the recipient does not approve the context, in step 1710 the voucher is notified that the vouch was not completed. In one embodiment this message will inform the voucher whether the recipient did not approve the context or did not approve the vouch, and may optionally include a comment from the recipient. In another embodiment this information is not returned to protect the privacy of the recipient. If the recipient approves the context, processing proceeds at step 1707.

Step 1705 of FIG. 17 is performed if the trust framework contract requires recipient approval of vouches or if the trust framework contract permits recipients to set a policy requiring approval of vouches. Since a vouch is a sign of positive reputation, this may not be necessary, however some principals may have a preference to control from whom they accept vouches. If vouching approval policies are supported, in step 1705 the agent processing the vouch determines if the recipient has a policy requiring approval. If so, the agent requests approval of the vouch from the recipient in the same manner described above for requesting approval of a context from the recipient. It then proceeds to step 1707. If not, it proceeds to step 1708.

In step 1707 of FIG. 17, if the recipient approves the vouch, the processes proceeds with step 1708, otherwise it proceeds with step 1710, described above. In step 1708 the agent adds the vouch in the logical reputation graph. In step 1709 the agent returns a confirmation to the voucher that the process has completed successfully.

The strong incentives a reciprocal trust network creates for principals to act in accordance with the rules of the trust framework contract should significantly reduce the potential for unwanted or unsolicited messages, commonly referred to as “spam”. In particular the second principle of the example trust framework contract illustrated in FIG. 13, Permission, commits members to request permission from other members prior to messaging. Given this restriction, it is possible that a member trying to skirt the rules may attempt a different unhealthy option for attracting the attention of another member: “vouching spam”. In this tactic, the voucher indiscriminately vouches for other members simply to attract their attention and curiosity as to the source of the vouch. In one embodiment vouching spam may be prevented from gaining a recipients attention by the use of a filtering ruleset operating at the principal's XDI message processing agent. In a server 120 (FIG. 1) this ruleset would be stored in database 122 and processed by the server engine 125. On a smart client 210 (FIG. 2) it would be stored in database 212 and processed by client processor 215. Such a ruleset is analogous to an email filtering ruleset. It may be installed network-wide, or at a particular data service provider, or only on behalf of a particular principal or group of principals. The ruleset may include rules that test the reputation of the voucher prior to interrupting the principal to request approval of a new context or a new vouch, or before notifying the recipient about addition a new vouch that does not require approval. The ruleset may also automate deletion of the vouch.

However a key drawback of filtering vouch spam at the recipient's end is that it puts the burden and network load on recipients and their agents. The higher upstream that filtering can occur, the less burden on the network. Ideally vouch spam is prevented at the source by building deterrents into the trust network. One deterrent is called a vouch ratio. A vouch ratio is calculated by dividing the number of incoming vouches a principal has received by the number of outgoing vouches the principal has made. The theory of a vouch ratio is that if a vouch is legitimate in a context, the voucher will in most cases have other relationships in that context, and those other relationships can be used to verify the voucher's legitimacy. A vouch ratio is most useful when applied to a specific context, however it may also be applied to a group of related contexts or to all contexts in which a principal has given or received vouches. A vouch ratio greater than 1.0, indicating that the principal has more incoming vouches than outgoing vouches, is a positive signal of reputation and integrity. A vouch ratio between 0.5 and 1.0 is a neutral signal. A vouch ratio significantly below 0.5, and especially below 0.1, is a warning sign. Thus the publication of the current vouch ratios for principals by the trust network serves as a deterrent to members who may be tempted to send vouch spam, since it adds a cost to every vouch a principal gives to another member if it is not reciprocated by a vouch from that member or from another member. Like all vouching, this signal is amplified when it is specific to a context. For example, a principal who has 1000 incoming vouches but only 10 outgoing vouches as a writer sends a strong positive signal about the principal's reputation as a writer. On the other hand, a principal who has only 10 incoming and 1000 outgoing vouches as a writer is sending a strong warning signal.

FIG. 18B illustrates an example visual display token for indicating a vouch ratio for a principal. This token would appear in an online context associating it with the principal, such as the principal's profile page, directory listing, virtual card, etc. This token includes a shape 1801. A rounded rectangle is illustrated but any shape may be used. Shape 1801 contains an indicator of the context. A text label is illustrated in FIG. 18B but an icon or any other signifier of the context may be used. An incoming arrow 1802 contains an indicator of the incoming vouches. An outgoing arrow 1803 contains an indicator of the outgoing vouches. In FIG. 18B a numeric a count of the incoming vouches and outgoing vouches is illustrated but any indicator of either the total amounts or the relative ratio of the amounts may be used. In an alternate embodiment the arrow containing the higher number is a solid color and the arrow indicating the lower number is either completely hollow, or hollow down to the ratio of the lower number to the higher. In the case of the illustration in FIG. 18B, incoming arrow 1802 would be solid and outgoing arrow 1803 would be half-full because the ratio of 7 to 14 is 50%. In yet another embodiment the arrow with the higher number is assigned one color and the arrow with the lower number is assigned a separate color. These approaches make it easy for a viewer to quickly perceive the direction of the ratio, particularly if a multiplicity of vouch ratio tokens representing different contexts associated with a principal are displayed. In another embodiment, numeric and graphic indicators are combined in each arrow.

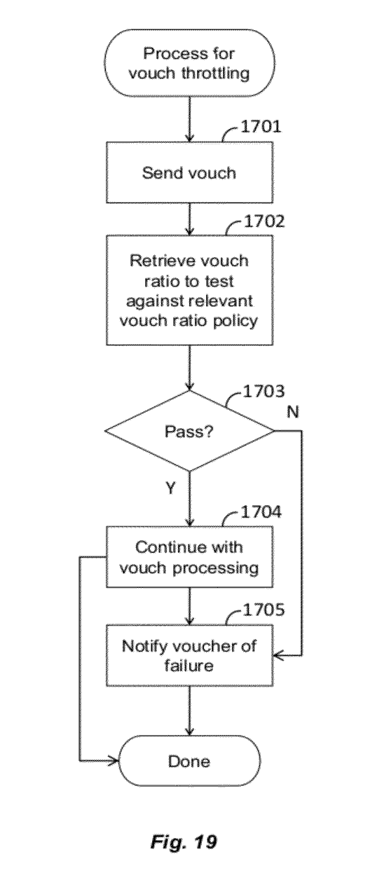

FIG. 19 illustrates a method for automatically enforcing vouch ratio policies, also called vouch throttling. Vouch throttling is a mechanism for applying rules at the network layer about the minimum vouch ratios necessary to send a new vouch, so these rules can be automatically enforced by agents of the trust network. Vouch throttling may be applied in a specific context using the vouch ratio for that context; it may be applied in one context using vouch ratios from one or more other contexts; or it may be applied to vouching in any context using the vouch ratios from one or more other contexts or from all contexts. Vouch throttling may be applied network-wide; in specific contexts; by specific data service providers; or by specific principals. In step 1901 of FIG. 19, the vouch is sent to an agent of the trust network that has been delegated to perform vouch throttling. If a vouch ratio policy is applied network-wide, all vouches subject to the policy must be processed by one of the agents delegated to perform this function on behalf of the network in order for the policy to be enforceable. Vouch ratio policies that are specific to a context or to a principal may be enforced by agents local to that context or principal. The particular agent or set of agents that perform this function is not a limiting feature of the invention. In step 1902 the agent requests the relevant vouch ratio from the logical reputation graph. In step 1903 the agent tests the vouch ratio against the vouch ratio policy. If it passes, in step 1904 the agent continues with vouch processing as described in the method of FIG. 17. If it fails, in step 1905 the agent notifies the voucher of the failure. In an embodiment this notification will include information about the policy that is the source of the failure if it is a network-wide policy, but not if it is context-specific or principal-specific as that may leak policy information that the context or principal does not want to reveal.

Another means by which a reciprocal trust network may using contextual vouching to incent and enforce trust relationships is by establishing a special context for signaling positive reputation with regard to compliance with the trust framework contract itself This is called the trust anchor context. In an embodiment of the trust framework contract, the contract establishes specific rules for vouching in the trust anchor context. For example, in the example Respect Trust Framework contract described above, the following rules are defined: a) all trust anchor vouches must be public, b) all trust anchor vouches must include an assertion that the voucher believes the recipient has one unique account on the trust network, c) if five trust anchors vouch for a principal in the trust anchor context, that principal is entitled to trust anchor status in the reputation graph, d) a principal with trust anchor status is limited to giving a maximum of 150 trust anchor vouches in the reputation graph any one point in time, and e) to bootstrap the initial population of trust anchors, the trust framework contract establishes rules for the trust network provider to appoint a set of founding trust anchors who may then propagate trust anchor vouches in accordance with the preceding rules. This set of rules is an embodiment of a solution to the Sybil attack on peer-to-peer reputation networks described in the Background section. Specifically, by establishing a known set of trusted principals, the founding trust anchors, and propagating trust anchor vouches only from this set of trusted principals, a reputation graph is formed that is not subject to gaming by creation of fake principals, also called “sock puppets”. This protection only applies to the graph of principals that are trust anchors, called the trust anchor graph. However the trust anchor graph may be used to determine policies relative to other contexts. For example, the community of members of a specific context such as an online discussion forum may grant certain privileges only to members who are trust anchors, or only to members who have at least a certain number of vouches from a trust anchors, or only to members that are at least two degrees from a trust anchor in the member's social network. Similarly, the trust network provider or a data service provider may grant certain privileges to trust anchors, such as the ability to add, modify, or link the contexts available in the logical graph. Such a policy helps protect the integrity of the logical graph in the same way Wikipedia administrators help protect the integrity of the Wikipedia online encyclopedia.

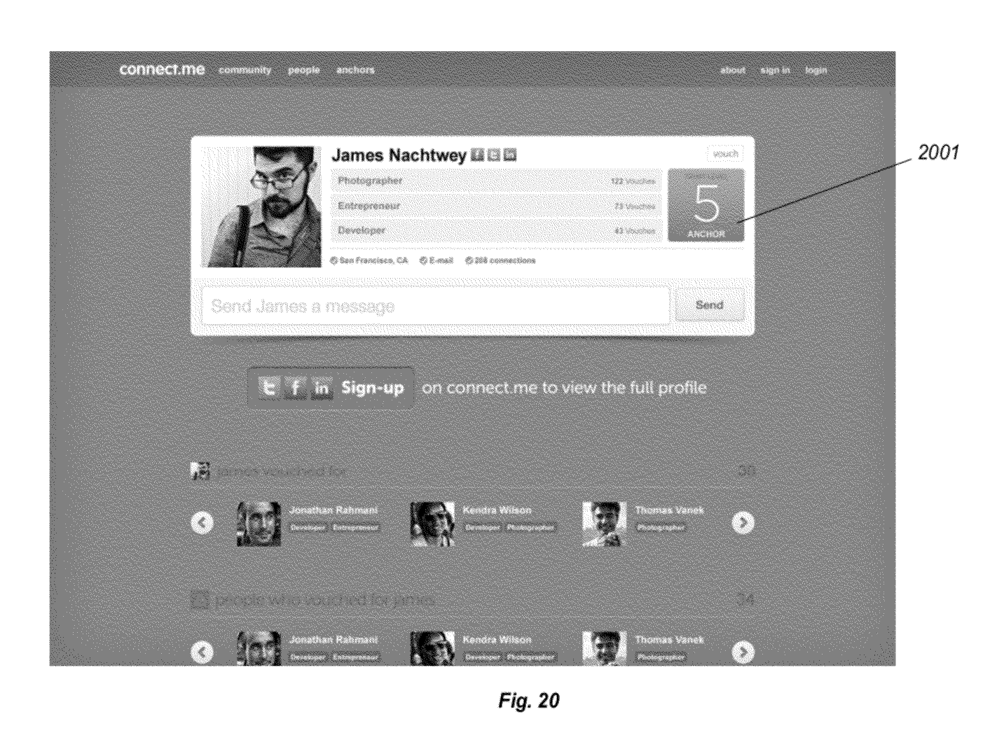

The special status and privileges accorded to trust anchors makes trust anchor vouches a particularly strong signal for both the voucher and recipient. Since this status is specifically associated with compliance with the trust framework contract, this is yet another mechanism for a reciprocal trust network to become self-reinforcing. The trust network provider can further amplify the strength of this signal by featuring it prominently in the form of a visual icon in user interfaces, screens, pages, or other embodiments or interfaces for the trust network where members are described or listed. This visual icon is called a trust anchor badge. FIG. 20 illustrates an example trust anchor badge 2001.

As described above, in an embodiment of the present invention, members of the trust network send signals of negative reputation to other members called complaints. The member issuing a complaint is called the complainant. The member receiving the complaint is called the recipient. This third form of signal between members of the trust network is especially strong because it is a signal of distrust. For this reason negative reputation must be handled carefully in reputation systems. A particular vulnerability is when negative reputation is used for “gaming”, i.e., when one or more members of the trust network conspire to assign negative reputation to another member in order to lower that member's reputation score. An example is when one or more competitors within an industry instruct their employees or hire third parties to write negative reviews of another competitor or its products. To protect against this form of abuse, an embodiment of the present invention includes a complaint resolution system.

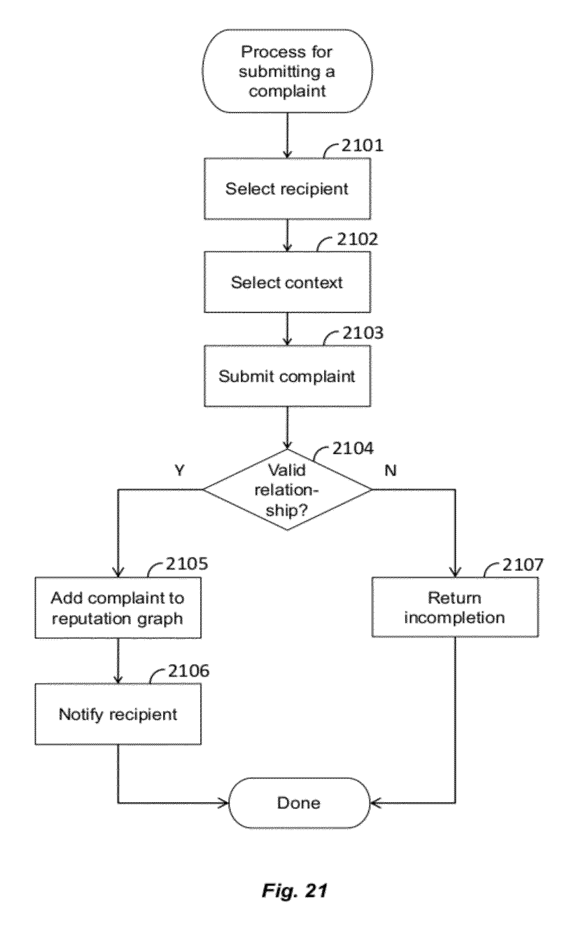

FIG. 21 illustrates an example method for issuing a complaint. In step 2101 the complainant selects the recipient against whom the complaint will be issued. In step 2102 the complainant selects the context for the complaint. The ability to assign a complaint in context is a distinguishing feature of the present invention. Just as a vouch is a signal of positive reputation constrained to a particular context, so can a complaint be a signal of negative reputation constrained to a particular context. For example, the statement, “Jack is a bad dentist” is much more limited in its damage than the statement “Jack is bad”. In step 2103 the complainant issues the complaint. This may take many forms. In one embodiment the context of the complaint is inherent, such as receipt of an incoming message that does not comply with a communications permission granted by the complainant to the sender of the message. In this case the complaint may be issued with a single action such as clicking a “Complaint” button. The resulting complaint can automatically include a copy of or reference to the offending message. In another embodiment the complainant is presented with a form to gather the relevant input, such as a textual description of the problem or action that resulted in the complaint. Such a form may also include other attributes or choices to facilitate processing and adjudication of the complaint. The particular form of the complaint input is not a limiting feature of the invention. In step 2104 the agent processing the complaint verifies that it is being made in the context of a valid relationship between the complainant and the recipient. While this step may be omitted in an alternative embodiment, it represents a particular complaint policy that may be enforced either by the trust network as a whole or by the community of members operating within a specific context. The advantage of a relationship validation policy is that it prevents the submission of complaints where there is no proof of a relationship in that context. For example, such a policy would prevent a university student from submitting a complaint in a teaching context against a professor from whom the student was not taking any classes. This is analogous to the policy in the eBay™ reputation system than buyers can only rate sellers with whom the buyer has engaged in a verified purchase transaction. Such a policy is readily enforced in an embodiment of the present invention by the agent verifying: a) if a link contract exists between the complainant and the recipient, and b) if that link contract includes a relationship in the same context as the complaint. If such a policy is in force and the agent does not find such a contract, in step 2107 the agent returns a notification that the complaint cannot be completed. However if a link contract is present that validates a relationship in the selected context, in step 2105 the agent adds the complaint to the reputation graph. In step 2106 the recipient is notified of the complaint. As described above, this notification can take place via the recipient's XDI endpoint so it may take advantage of communications routing rules and capabilities active there. In particular, a rule may operate that assigns a high priority channel for notification of the recipient about receipt of a complaint because of its potential negative impact on the recipient's reputation.

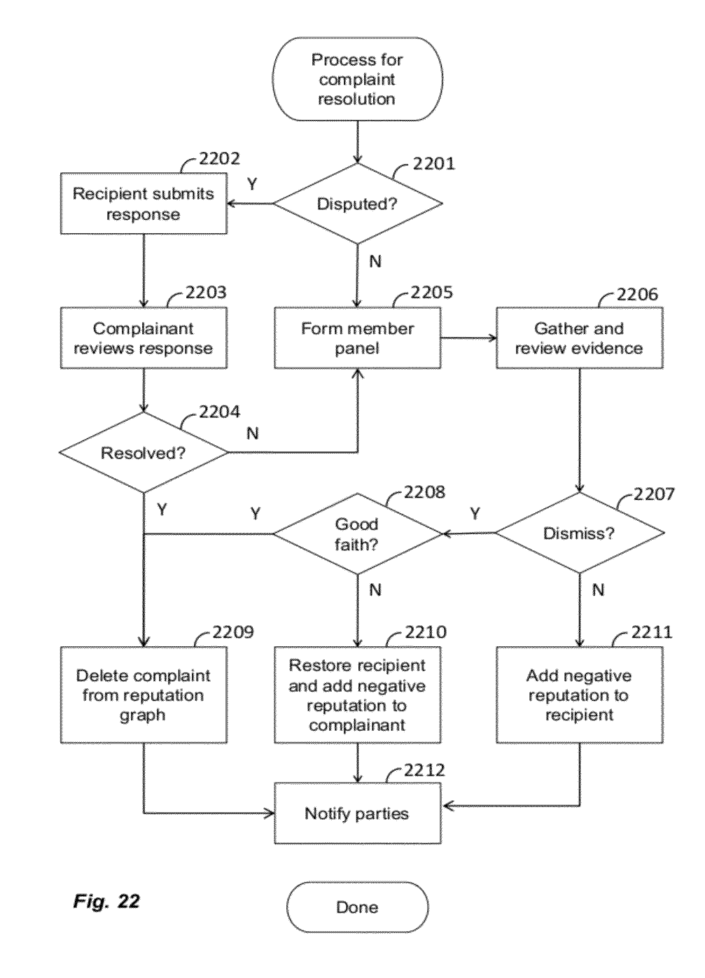

FIG. 22 illustrates an example method for complaint resolution. In step 2201 the process begins with the complainant deciding whether to dispute the complaint. If not, processing continues directly with step 2205 below. If so, in step 2202 the recipient submits a response to recipient's agent indicating the intention to dispute and providing such information or evidence as recipient believes may resolve the dispute. The recipient may use any method or approach to resolving the complaint such as making an apology, refunding a purchase, offering a discount or coupon, or any other action that will resolve the dispute. In step 2203 the response is delivered to the complainant who reviews it to decide whether the issue can be resolved. If necessary this correspondence cycle between complainant and recipient can iterate until a decision of resolution or escalation is reached by complainant. In step 2204 this decision is made. If the complainant indicates the complaint is resolved, in step 2209 the complaint is deleted from the reputation graph. In an alternative embodiment the fact that a complaint has been successfully resolved may be retained as part of the reputation graph of either party. If in step 2204 the complaint is not resolved and must be escalated, in step 2205 a panel of members is formed. The panel may be composed of any number of members that represents a fair and efficient body to perform adjudication. This is a lightweight version of the process of choosing arbiters in arbitration or empanelling a jury in a court of law. The equivalent of choosing a “jury of one's peers” in the trust network of the present invention is selecting the panel from among members of the trust network. Selection may be made from all members, or the complaint resolution process may define specific qualifications. In one embodiment, the qualification is that panel members must be selected from the special subset of the reputation graph represented by trust anchors as discussed above. This has the particular advantage of selecting members from the community whose peers have specifically vouched for their integrity in abiding by the trust framework contract. In step 2206 the member panel gathers any necessary evidence to render a decision. This may include reviewing the complaint, reviewing correspondence between the complainant and recipient, and requesting further input and rebuttal from the parties. In step 2207 the panel renders their decision. If the decision is to uphold the complaint, in step 2211 the panel adds the complaint and makes any other negative reputation adjustment deemed justified to the recipient's reputation graph. This may include removing trust anchor status if the recipient was a trust anchor, adding a vouch discount factor, imposing a period of suspension for further vouches, or any other action consistent with the policies of the trust network for complaint resolution. If in step 2207 the decision is to dismiss the complaint, in step 2208 the panel renders a second decision, which is whether the complaint was made in good faith, i.e., that complainant had a legitimate reason to make the complaint even though it was not upheld. If so, step 2209 is completed and the complaint is deleted from the reputation graph of both parties. If in step 2208 the finding of the panel is that the complaint was not made in good faith, but represented an attempt to game the reputation system, harass the recipient, or otherwise advance the interests of the complainant at the expense of the recipient, in step 2210 the panel removes the complaint from the recipient's reputation graph and adds the complaint and makes any other negative reputation adjustment deemed justified to the complainant's reputation graph. This is important because it establishes a clear and tangible reputation cost for making a complaint in bad faith. This creates a counterincentive to abuse or gaming of the peer-to-peer reputation system. The involvement of human judgment in the form of the member panel that performs adjudication of disputed complaints provides an effective means for dealing with the highly advanced techniques that have and will be developed for gaming or subverting peer-to-peer reputation systems. It also has the advantage of turning the entire population of trust network members into a “neighborhood watch” to keep an eye out for potential abuses. In all cases, after the decision of the panel decision is rendered and adjustments to the reputation graph are made, in step 2212 the parties are notified of the outcome and the process is complete. In an alternative embodiment the complaint resolution process may also provide for an appeals process or other forms of relief.

Another advantage of the present invention is that it enables a simpler, safer, more convenient, and more valuable ways to connect members of a trust network and perform digital relationship management functions. A specific example is the capability to initiate new digital relationships, activate functions within existing digital relationships such as authentication or authorization, and terminate digital relationships using a single user interface affordance. This affordance may take many different forms including a standardized visual icon, a standardized word or phrase, a trademarked word or phrase, or a standardized operating or peripheral system function such as a menu option, mouse button, or keyboard function key. This affordance may appear in different forms on different types of devices, such as mobile phones versus laptop computers, or in different user interfaces, such as graphical user interfaces and text-based or voice-based user interfaces. The particular form of this affordance is not a limiting feature of the invention. In the context of the field of vendor relationship management (VRM), this affordance is generally referred to as a “relationship button” or “r-button”. In the context of social login services from companies like Facebook and Twitter, it is generally referred to as a connect button. In this specification it will be referred to as a connect button.

Embodiments of the present invention incorporating a connect button offer multiple advantages for both providers and users of the connect button. First, the connect button provides a means for the provider to quickly and easily signal the user about the level of trust the provider offers for personal data shared via the trust network. Second, the connect button implemented on a server is able to provide approximately the same functionality regardless of whether the server is accessed via a dumb client or a smart client. Thirdly, the connect button enables easy and direct access to all the relationship management functions of the user's XDI endpoint. Fourth, the connect button can provide new digital relationship management functions and actions and if desired signal the user about the availability of such options as further described below. Fifth, the connect button can be used to manage both exchange of conventional payments and exchange of relationship value as further described below.

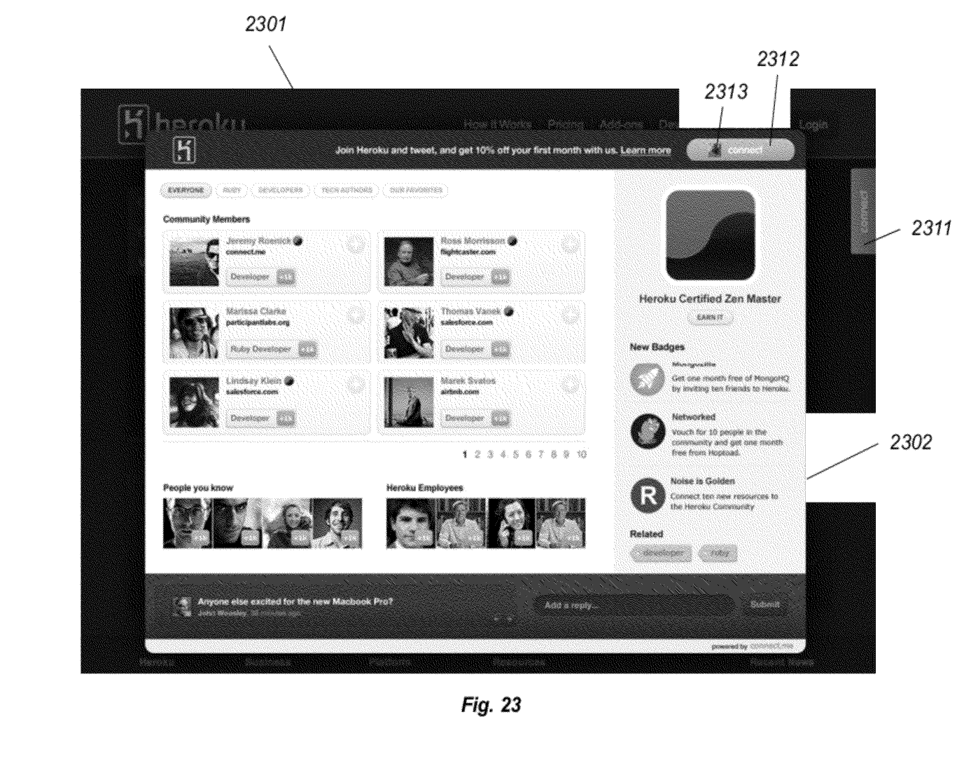

FIG. 23 illustrates an example connect button. In this embodiment Web page 2301 displays connect button 2311 as a user interface affordance commonly called a “side tab”. Connect button 2311 includes the word “connect” in a distinctive font and color and also appears in a standard position on the web page, i.e., as a side tab in the upper right corner of the Web page. In another embodiment the word displayed in connect button 2311 would be a trademark such as Connect.Me™, a trademark of Respect Network Corporation. In another embodiment the connect button 2311 would include a visual icon such as the Connect.Me logo. In another embodiment the connect button 2311 could appear directly in the chrome of the browser or the menu bar of the browser. In another embodiment positioning of the connect button as a side tab, top tab, bottom tab, or in the chrome (menu area) of the browser or other user interface agent is controlled by user preferences stored at the user's XDI endpoint and retrieved by a browser plug-in to a dumb client 110 (FIG. 1) or by a smart client 210 (FIG. 2).

FIG. 23 also includes a second illustration of an example connect button. This secondary connect button 2312 appears on secondary Web page 2302. Secondary Web page 2302 is generated by server 121 in response to the user clicking on the primary connect button 2311. Secondary Web page 2302 illustrates a range of the different relationship management functions that may be accessed through a connect button as further described below. Secondary connect button 2312 also includes an additional visual signal in the form of user thumbnail 2313. User thumbnail 2313 is a means of signaling the principal for the digital identity accessed by primary connect button 2311 that secondary Web page 2302 has been retrieved from the principal's own XDI endpoint and is authentic.

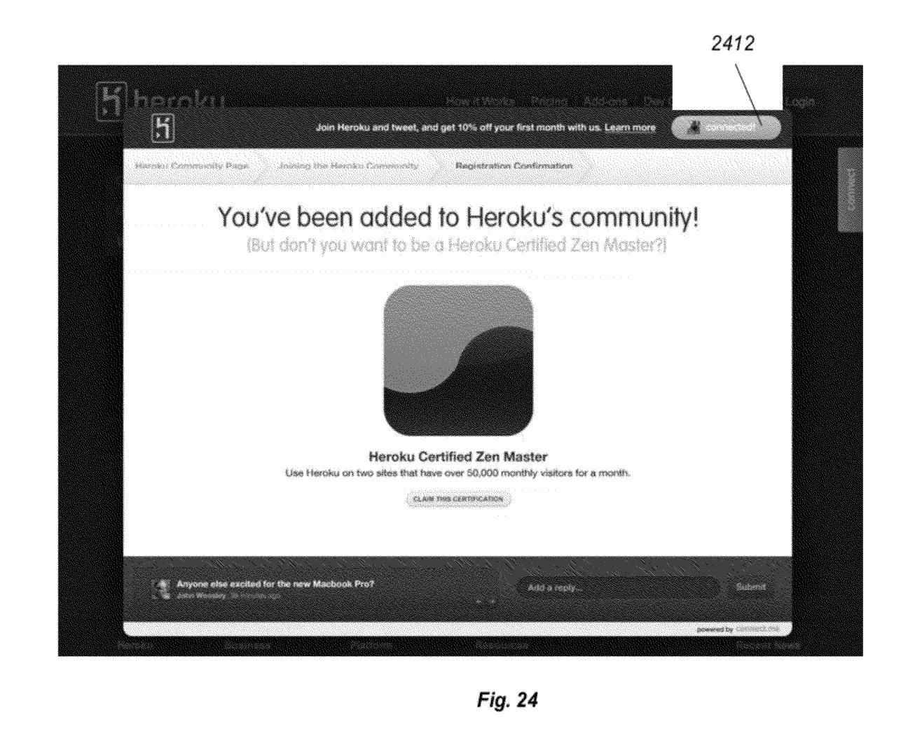

FIG. 24 illustrates an example connect button in a connected state. Connect button 2412 is identical to connect button 2312 except the principal has taken an action that has resulted in establishing a relationship between the digital identity of the principal and the digital identity of the site with which the principal is interacting. This relationship is called a connection as further described below. Another advantage of a connect button in an embodiment of the present invention is that it may signal the principal about the state of a relationship with the digital identity responsible for the Web page, service, application, or other resource with which the user is interacting.

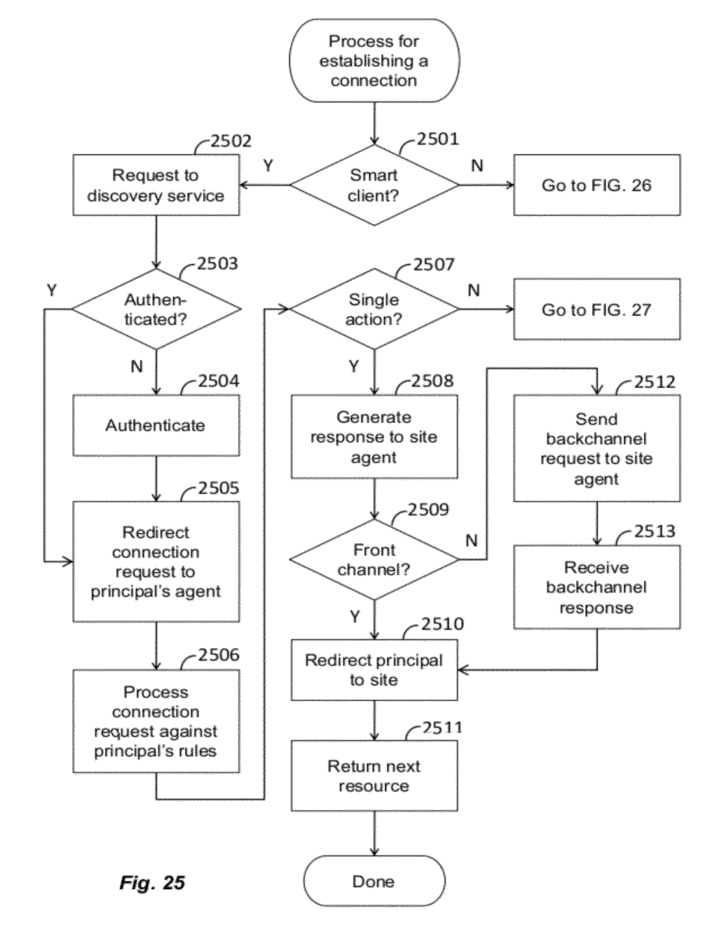

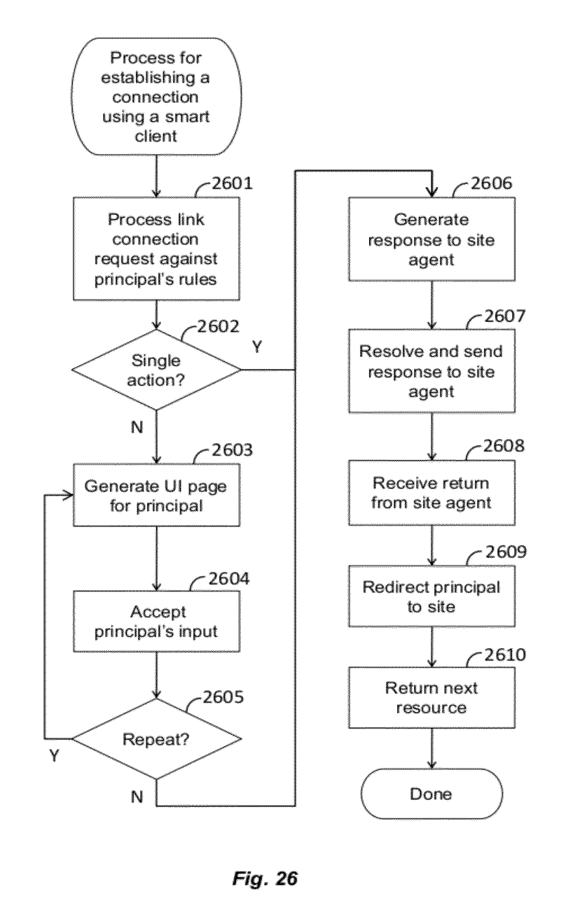

FIG. 25 illustrates an example method for establishing a connection relationship using a connect button. Such a relationship may be initiated via either the primary connect button 2311 (FIG. 23) or the secondary connect button 2312 (FIG. 23) depending on the preferences of the principal and the site. The behavior of whether a connection relationship is established in a single action or in more than a single action may be controlled by rules or preferences stored in database 122 (FIG. 1) in the case of a dumb client 110 (FIG. 1) or database 212 in the case of a smart client 210 (FIG. 2). When a principal activates a connect button, such as by clicking it, in step 2501 the logic branches depending on whether this action is received by a smart client 210 (FIG. 2) or dumb client 110 (FIG. 1). If a smart client 210, processing proceeds as described in FIG. 26. If a dumb client 110, in step 2502 the browser 111 issues a request to the trust network discovery service operated on one or more servers 120 (FIG. 1) by the trust network provider. This service listens for discovery requests from dumb clients 110. In an embodiment these requests are http: or https: URIs that follow a template specified by the trust network provider to pass the necessary connection request to the principal's agent. In one embodiment this template is structured so the base URI is the address of the trust network discovery service and the path is the XDI address of the XDI connection request message. For example, if the trust network discovery service base URI is http://xdi.example.com, the i-number of the digital identity of the site making the connection request is @!3333, and the connection request message i-number is !1234, the resulting example URI would be:

https://xdi.example.com/@!3333$msg!1234

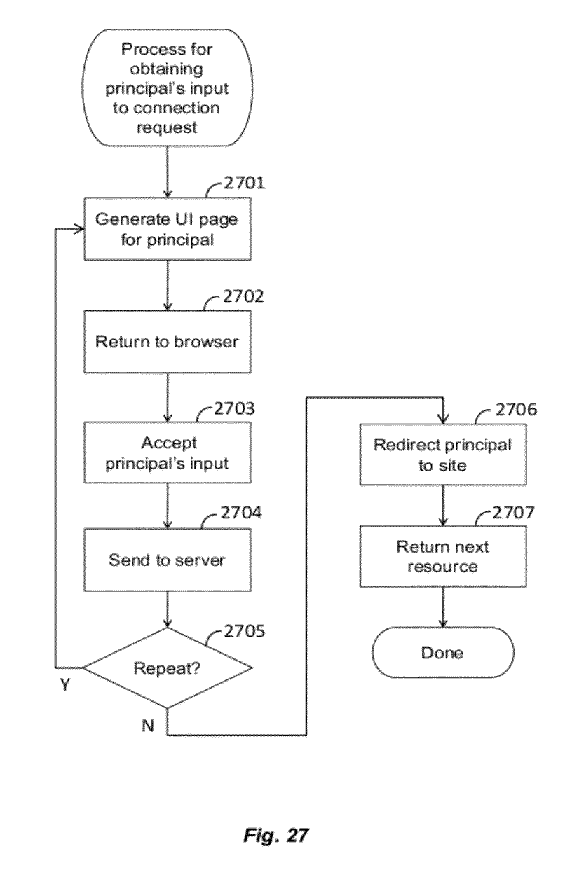

In step 2503 the trust network discovery service receives the request and checks to see if the principal's browser session is authenticated with the network. If so, processing proceeds with step 2505. If not, in step 2504 the principal must be authenticated. As described above, the trust network can perform authentication centrally, or it may federate authentication by delegating it to the data service provider where the principal is registered. With dumb client 110 such delegation may be performed by processing a cookie returned by browser 111, previously set by the trust network discovery service, and then redirecting the principal's browser 111 to the data service provider for authentication. If no cookie is set, the trust network discovery service may challenge the principal to provide the information necessary to discover the principal's data service provider. Such challenge may include requesting any data or relationship registered with the trust network provider for discovery purposes, including an i-name, an OpenID URI, an email address, or a social login service such as those available from Twitter, Facebook, and LinkedIn. Unless the trust network provider is serving as the principal's agent, or unless federated authentication has already resulted in the principal's browser 111 being redirected to the principal's agent, in step 2505 this redirection is performed and the connection request is passed to the principal's agent. In step 2506 the principal's agent processes the connection request. In the XDI protocol, a connection request is embodied as a request to add a link contract as illustrated in FIG. 5. Such a request may optionally include a request to return ($get) a subgraph of data from the principal's graph. The principal's agent verifies the signature on the XDI message and then processes the permissions requested by the link contract ($get, $add, $mod, $del relations) and the policies referenced by the link contract ($for relations) against the principal's rules. In step 2507 the principal's agent determines whether, according to the principal's rules, the connection can proceed entirely automatically in a single action, i.e., by completing the current connection request without further intervention or input from the principal. If not, processing proceeds as described in FIG. 27 below. If so, in step 2508 the principal's agent generates a response to the site's agent. This response includes acknowledgement of the link contract. In an embodiment this is performed by sending an XDI $add operation with principal's digital signature on the link contract to the site's agent to add to the site's logical graph. If the connection request included a $get for a subgraph of data from the principal's graph, this subgraph is also returned in the response. In step 2509 the principal's agent determines if the response should be send “front channel” or “back channel”. In the front channel option, the response is delivered though a redirect of the principal's browser 111 back to the site's agent. In the back channel option, the response is delivered via a direct XDI request/response interchange between the principal's agent and the site's agent. There are merits to both options as reflected by the different front channel and back channel versions of the SAML protocol from the OASIS SAML (Security Assertion Markup Language) protocol, the OpenID protocol from the OpenID Foundation, and the OAuth protocol from the IETF. The particular front channel or back channel option used to deliver the response is not a limiting feature of the invention. If front channel is used, in step 2510 the response is delivered and the principal's browser 111 is redirected back to the site. If back channel is used, in step 2512 the principal's agent resolves the XDI endpoint for the site's agent and sends the connection response as an XDI request. In step 2513 the principal's agent receives the response from the site's agent, and then redirects the principal's browser 111 to the site in step 2510. In step 2511 the site processes the connection response to add the principal's digital identity and requested subgraph to the site's logical graph and then returns the next resource to the browser 111 based on the principal's new state of having established a connection with the site.

FIG. 26 illustrates a continuation of step 2501 of FIG. 25 using a smart client. If a connect button 2311 (FIG. 23) is activated using a smart client 210, it intercepts the trust network discovery service address and processes it locally instead. This means in step 2601 smart client 210 may proceed immediately to processing the connection request as described in step 2506 of FIG. 25. In step 2602 smart client 210 makes the same single action determination as in step 2507 of FIG. 25. If the decision is yes, in step 2606 smart client 210 generates a response as in step 2508 of FIG. 25. In step 2607 smart client 210 resolves the XDI address of the site's agent and sends the response message. In step 2608 the site's agent processes the response as in step 2511 of FIG. 25, except because it is communicating directly with smart client 210, it returns the instruction about where to redirect the principal's browser 111 to smart client 210. In step 2609 smart client 210 redirects the principal's browser 111 as directed by the site's agent. In step 2610 the site returns the next resource to the browser 111 based on the principal's new state of having established a connection with the site. If, in step 2602, the principal's rules do not result in processing of the connection request in a single action, in step 2603 smart client 210 generates a UI interface page or screen (depending on the device) to accept the principal's input regarding the connection request. This input may include a wide range of relationship management choices, such as what personal data to share with the site, what personalization preferences to use for the site, what relationships to share with the site, whether the principal's relationship with the site should be visible to other members of the site (or only other members who have a connection with the principal), whether single-action login or automatic login is desired for future visits to the site, or whether the principal wishes to vouch for or endorse the site (endorsement is discussed below). This specific relationship management options offered is not a limiting feature of the invention. In step 2604 smart client 210 accepts the principal's input and processes it. In step 2605 if additional input is necessary the smart client 210 returns to step 2603, otherwise it proceeds to step 2606.

FIG. 27 illustrates a continuation of step 2507 of FIG. 25 if a connection request by a dumb client is not completed in a single action. The steps in this method are very similar to those in FIG. 26 except they are performed remotely by the principal's agent operating on a server 120 instead of a smart client 210. In step 2701, the principal's agent on server 120 (FIG. 1) generates a Web page 121 as in step 2603 of FIG. 26. In step 2702 principal's agent returns the page to browser 111. In step 2703 browser 111 accepts principal's input. In step 2704 the principal submits the page and browser 111 sends it to server 120. In step 2705 server engine 125 (FIG. 1) processes the input and determines if addition input is necessary. If so, it returns to step 2701. If not, it proceeds to step 2706 where it redirects the principal's browser 111 to the site. In step 2707 the site returns the next resource to the browser 111 based on the principal's new state of having established a connection with the site.

These exemplary methods of using a connect button have several distinct advantages. First, an embodiment of the connect button that displays the brand of the trust network as described above is a simple but powerful means for a site to send the first signal described in the discussion of contract theory above. It is a signal to a principal that the site is a member of the trust network and agrees to the promise of reciprocal trust represented by the trust framework contract. This has significant value to a site for two reasons: a) it reduces the friction for registration and login, and b) it reduces the anxiety a principal may feel about the lack of privacy or lack of control represented by other connection options, such as the social login services available from social networks like Facebook. Secondly, the connections formed in this manner are subject to the rights and privileges of members of the trust network, for example the portability principle described in FIG. 13. This increases the value of the relationship for both the principal and the site because there is no barrier to the relationship persisting even if the principal changes data service providers. Thirdly, the connect button provides a single ceremony for digital relationship management functions such as site registration, login, or preference management that is uniform across both dumb clients and smart clients. This is both convenient for principals and a significant adoption advantage since adoption is not hindered by the need for principals to download and install a smart client 210. Forth, by employing rules in the database 122 (FIG. 1) or 212 (FIG. 2), the principal can control when the connect button results in a single action for processing a connection request or in multiple actions. To further simplify decision making for the principal, these rules may operate against the reputation graph. For example, if a site has sufficiently positive reputation, or if the site has a sufficient number of active connections with members of the principal's social networks, or if the site has a connection to one or more contexts that match the principal's contexts, a connection request may be processed automatically instead of requiring further review by the principal. Fifth, the act of entering into a connection may be an additional input into the reputation graph of either the site or the principal or both. Although it is not as strong a signal as a vouch, a connection is nonetheless a signal that enough value was perceived in a relationship that the principal took the time to create one and the site accepted it. The number of connections to a member from other members of the trust network may be used as a positive reputation factor similar to the way the number of links to a page from other pages is used in the Google® PageRank® algorithm. The potential to use this input for reputation calculations is significantly enhanced by the anti-gaming protections provided by trust anchors as discussed above.

An additional advantage of these methods of connecting members of a trust network is that they permit members to recognize the value of these relationships and to engage in relationship value exchange. In the field of value network analysis this is referred to as the conversion of intangible value into tangible forms of value such as financial currencies or prices. In customer relationship management (CRM) systems, businesses aggregate customer data from all touchpoints within an organization as well as from outside sources in order to learn as much as possible about a customer and maximize the customer's lifetime value. The present invention provides the ability for a CRM system to connect directly to the customer's own relationship management system in the form of the principal's agent and XDI endpoint through a trust network that provides both parties with incentives to maintain a trust relationship. This enables the business to learn more about the customer and develop a more intimate relationship. In most cases this will increases the value of the customer to the business and the value of the business to the customer. The present invention provides a means by which a portion of this value may be shared back with the customer as a reward for establishing or further developing a relationship. This is similar to the rewards offered by loyalty programs such as airline mileage programs, hotel rewards cards, and frequent shopper cards. The differences are that: a) this relationship value exchange may “flow” directly over the connection transactions described above, b) the relationship value may be converted into a digital currency in order to be fungible across different contexts and relationships, and c) the exchange may reflect the value of either the principal's or the business' reputation in the trust network.

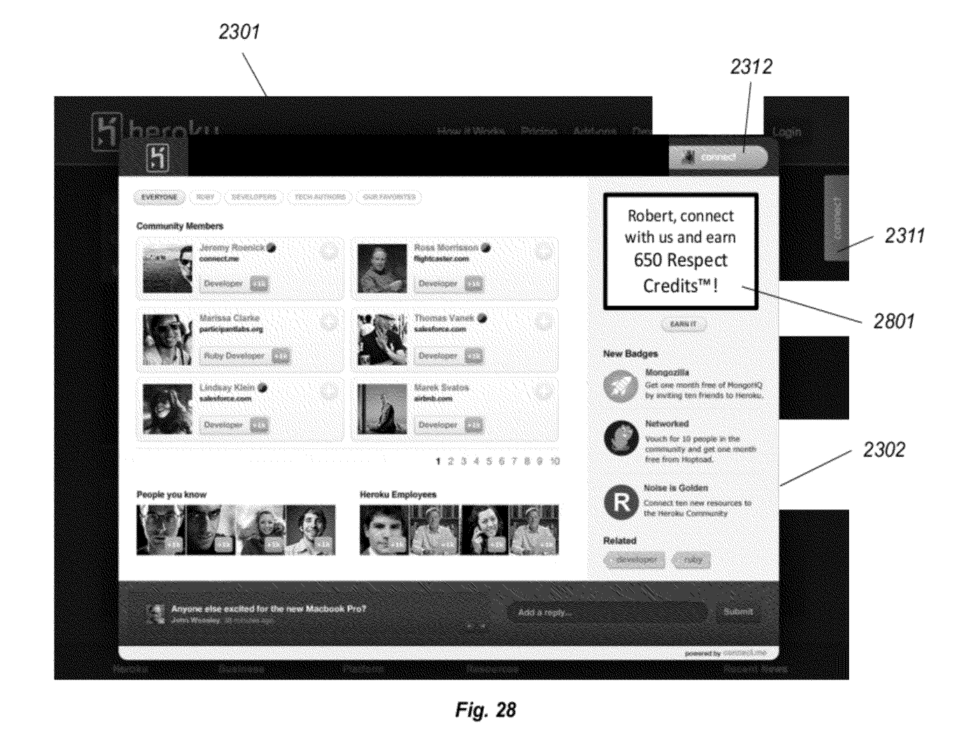

FIG. 28 illustrates an example relationship valuation screen. This is similar to FIG. 23 except it displays a relationship value exchange offer 2801. Generation of this offer is described below. Offer 2801 reflects a valuation using a digital currency called Respect Credits™, a trademark of Respect Network Corporation. In other embodiments the valuation in offer 2801 could be reflected using financial currencies such as the U.S. dollar or British pound, in other digital currencies, or in other loyalty program valuation units such as airline miles. The particular currency used is not a limiting feature of the invention.

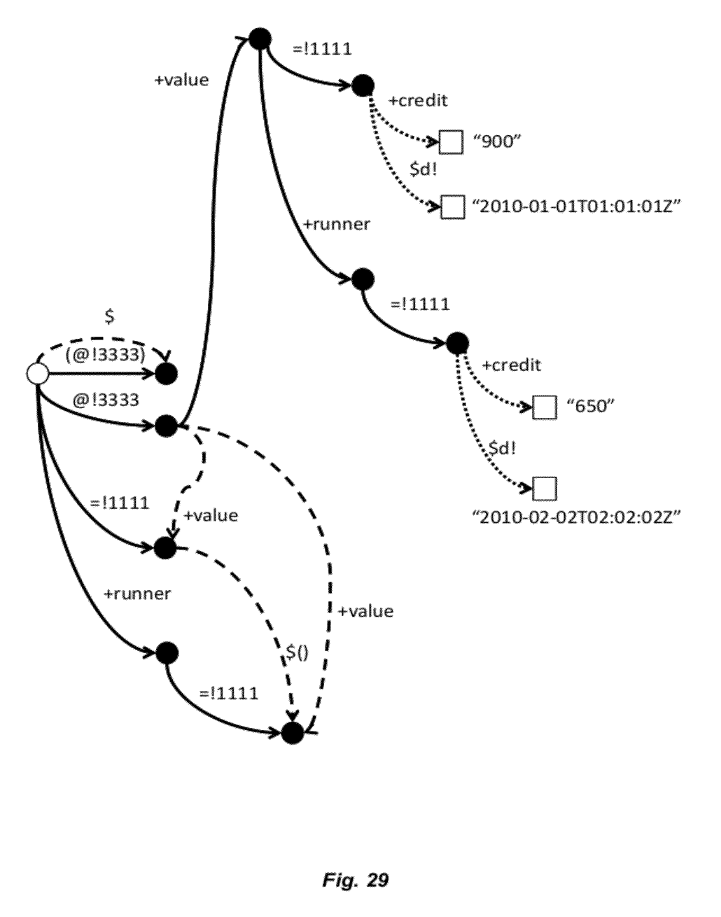

FIG. 29 illustrates an example XDI graph representing a relationship valuation. This is similar to FIG. 16 where reputation relationships are expressed with relational arcs labeled +vouch. In FIG. 29 valuation relationships are expressed with relational arcs labeled +value. As with FIG. 16, the relationships expressed in FIG. 29 may be in any context. FIG. 29 illustrates two such valuation relationships, one to the root context of the digital identity =!1111, and one to the same digital identity within the +runner context. As with the relationship metadata expressed in FIG. 16, metadata on the relational arcs labeled +value is expressed through the contextual arc +value. Specifically it is expressed using the literal arc labeled +credit originating in the +value=!1111 context node and the +value+runner=!1111 context node. The +credit arc is an example of a vocabulary for expressing relationship value as a digital currency such as Respect Credits, discussed above.

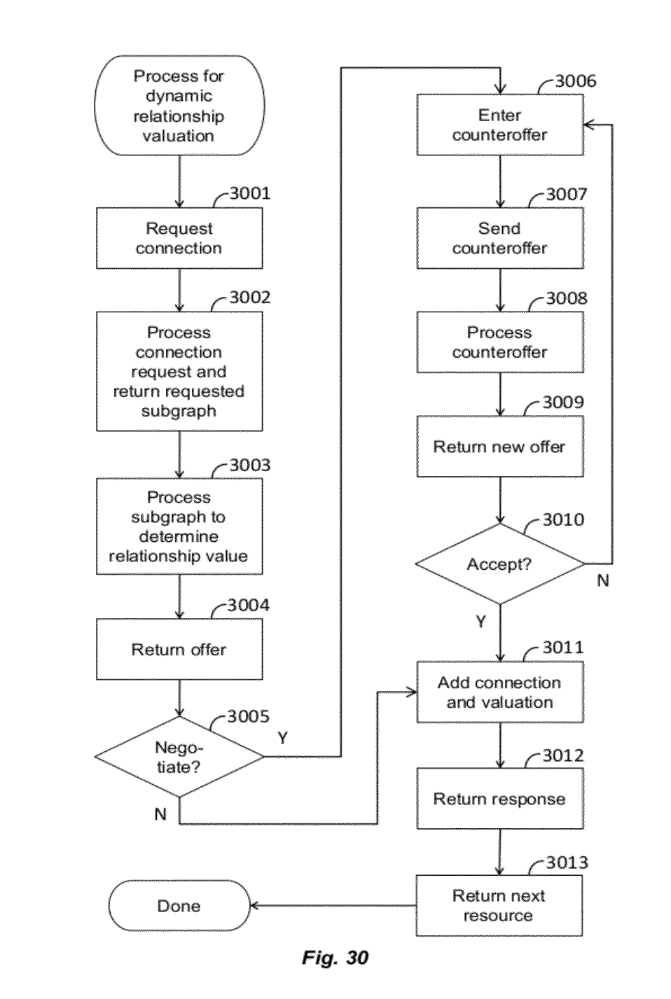

FIG. 30 illustrates an example method for determining relationship valuation dynamically. This method is an extension to the connection methods described above that adds the steps necessary for relationship value exchange. In step 3001 the principal makes the connection request, such as by clicking a connect button 2311 (FIG. 23). In step 3002 the connection request is processed by the principal's agent and the requested subgraph returned to the site's agent as per FIGS. 25 and 26. This subgraph may include any data, metadata, or relationship data, including all or a portion of the principal's reputation graph, that is requested by the site and which the principal agrees to release in order to make a relationship valuation determination. In step 3003 this subgraph is processed by the site's agent to determine the proposed relationship value. This determination may take into consideration any of the data returned that may affect the valuation decision, including demographic or psychographic data, financial data, purchase histories, buying intentions, wishlists, contexts, vouches, complaints, and so on. In step 3005 the site's agent returns a valuation offer such as illustrated in FIG. 28 by offer 2801. In one embodiment negotiation is not an option and the process would end here with the principal making a decision whether to accept the offer or abandon establishing the connection. In the embodiment illustrated in FIG. 30, negotiation is supported if the valuation offer returned in step 3004 includes options to adjust the valuation. Such options may include sharing additional data, providing feedback, taking a survey, recommending friends, and so on. In step 3005 the principal determines whether to accept the offer or negotiate. If the offer is accepted, processing continues at step 3006. If the principal chooses to negotiate, the principal selects the desired option or options and provides the data or actions necessary to produce the counteroffer. In step 3007 the principal's agent sends the counteroffer to the site's agent. In step 3008 the site's agent processes the counteroffer to determine the new offer. In step 3009 the site's agent returns the new offer. In step 3010 the principal decides whether to accept the new offer. If not, either the transaction is abandoned or the negotiation cycle repeats from step 3006. If the principal accepts the offer, in step 3011 the principal's agent adds the connection and valuation from the site to the principal's logical graph. In step 3012 the principal's agent returns a response accepting the offer to the site's agent, which adds the connection and valuation to the site's logical graph. In step 3013 the site returns the next resource to the principal based on the principal's new state of having established a connection with the site with an established valuation.

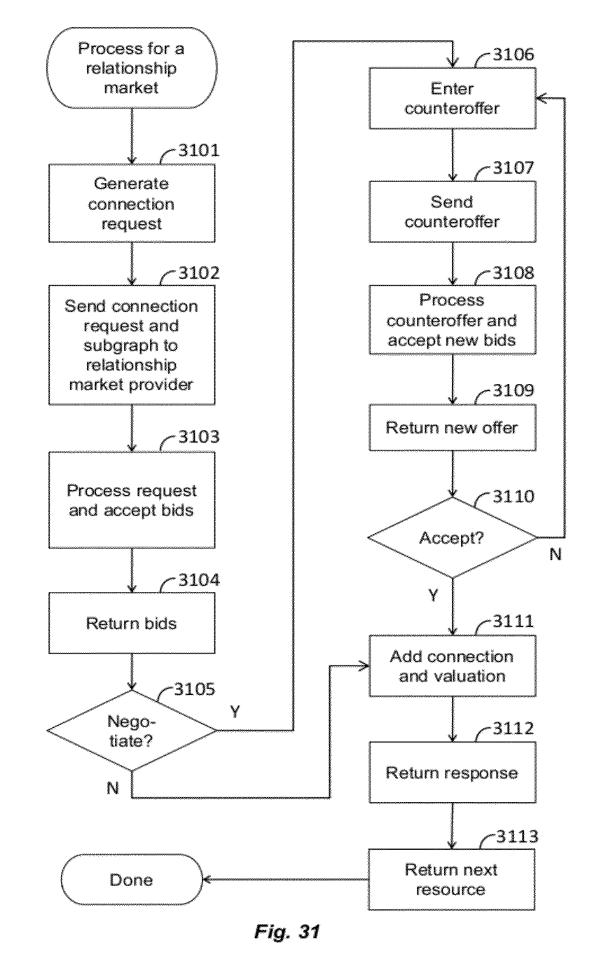

FIG. 31 illustrates an example method for determining relationship valuation via a market mechanism. It is very similar to FIG. 30, consisting of the same overall sequence of steps, however the key difference is that the connection request is not negotiated with a single site, but with a service provider who serves as broker or market maker for relationship value transactions with multiple sites. In this specification this role will be referred to as a relationship market provider. In step 3101 a connection request is generated. In contrast with step 3001 of FIG. 30, where the request was generated by the site, this request may come from multiple sources. For example, it may be generated directly by the principal, using functions available in the principal's agent, to reflect a particular market intention, such as to buy a particular product or type of product. It may be generated by a relationship market provider to reflect a common market need or relationship type. It may be generated by a site specializing in developing connection requests for a relationship market. In step 3102 the connection request is sent to the relationship market provider. In an embodiment the relationship market provider is a member of the trust network operating one or more servers 120 (FIG. 1), and therefore this connection request is processed by the relationship market provider's agent. In step 3103 the relationship market provider's agent processes the request and matches it against bids for a relationship meeting the same requirements. This process may use any matching technology or algorithm capable of producing the desired matches. The matching technology is not a limiting feature of the invention. In step 3104 the set of matching bids are returned to the principal's agent. In step 3105 the principal decides whether to accept one or more of the bids (the connection request may or may not have been exclusive), or to negotiate. If the principal accepts, processing proceeds with step 3106. If negotiation is chosen, in steps 3106 and 3107 the principal follows the same procedures as steps 3006 and 3007 of FIG. 30. In step 3108 the relationship market provider's agent processes the counteroffer and accepts new bids. In step 3109 the relationship market provider's agent returns the new offer or offers. In step 3110 the principal decides to accept or continue negotiations. If the decision is to continue, processing returns to step 3106. If the principal accepts the bid or bids, in step 3111 the principal's agent adds the new connection or connections and valuation received to the principal's logical graph. In step 3112 the principal's agent returns a response or responses to the winning bidder or bidders. In step 3113 the winning bidder's agent or bidder's agents record the new connection and valuation in their logical graphs and returns the next resource to the principal based on the principal's new state of having established a connection with the winning bidder with an established valuation.

A particular advantage to this market mechanism for determining relationship value in the trust network of the present invention is that it provides a mechanism for making reputation value fungible by making it an input to relationship valuation. Furthermore, when the exchange of relationship value performed through the methods of FIGS. 30 and 31 uses an interoperable digital currency, it adds the property of fungibility across members of the trust network. The value further increases if the digital currency is further fungible into financial currencies. Both roles can be facilitated by the trust network provider or by a separate digital currency provider.

A relationship market may further benefit from two additional market mechanisms. The first is group buying. In group buying, such as practiced by GroupOn™, LivingSocial™, and their competitors, the power of a buying group is used to attract highly discounted pricing from a seller. A key drawback to this mechanism is that the seller determines the offer that is placed before the group. Then the offer “tips”, or becomes valid, if sufficient buyers take the offer. This means sellers must guess both at what offers buyers will take at what time and at what discounted price. A more efficient market will result if the buyers are able to determine those factors, i.e., what offers a buyer is interested in when and at what price. Buyers may also wish to set other terms, such as the geographic location of the offer, the reputation of the seller, or the number of friends or associates the buyer is willing to bring into the offer (such as a restaurant meal, party, or vacation). This process, sometimes referred to as “reverse group buying”, is very well suited to the relationship market mechanism disclosed in FIG. 31. The only difference in processing necessary to support reverse group buying is: a) the relationship market provider collects a multiplicity of connection requests to put out to bid, and b) each buyer indicates their buying requirements such as product type, product quality, timeframe, pricing threshold, and so on. In an embodiment of the present invention a reverse group purchasing mechanism has the additional advantage of having each buyer's reputation and each seller's reputation as an input to the bidding process, so buyers can qualify sellers by reputation before committing to buy and sellers can qualify buyers by reputation before committing to sell.

The second market mechanism that can benefit a relationship market is endorsements. An endorsement is a special form of positive reputation signal that is more valuable than a vouch because it is exclusive in a context. For example, a golfer may have relationships with several golf ball manufacturers, and purchase and use golf balls from all of them, yet the golfer may only endorse one of them. The principle of the value of exclusive endorsement is easily seen in the market for professional endorsements. A famous athlete such as Arnold Palmer may endorse a particular product in a particular category, such as a brand of golf balls. As long as that endorsement is exclusive in that category, it has substantial value to the seller. Arnold Palmer may give other endorsements in other categories, such as golf carts or resort hotels or cruise lines, without diminishing the value of the golf ball brand endorsement. But if Arnold Palmer were to endorse a second brand of golf balls from a different manufacturer, it would dramatically lower or even destroy the value of both golf ball brand endorsements.

In a relationship market with an integrated reputation system, the power and value of endorsements can be extended to all members of the network. Every member of the network who buys products and services can enter into endorsement relationships for the brands about which the member feels strong enough to make an endorsement. The value of such endorsement is even higher if the reputation system rule is that all endorsements must be public on the reputation graph of both the endorser and the endorsee. Furthermore, by extending the power of endorsement to potentially all customers in a market, and providing a reputation system with the protections from gaming discussed herein, the endorsement scores for different brands in different categories become an objective market measurement of the brand's reputation. In marketing this is known as a brand's net promoter score, which is derived from compiling answers to the question, “How likely is it that you would recommend a company to a friend or colleague?” on a score of 1 to 10. This is considered by many business executives to be the single best indicator of a company's future success, so it is a highly valuable metric.

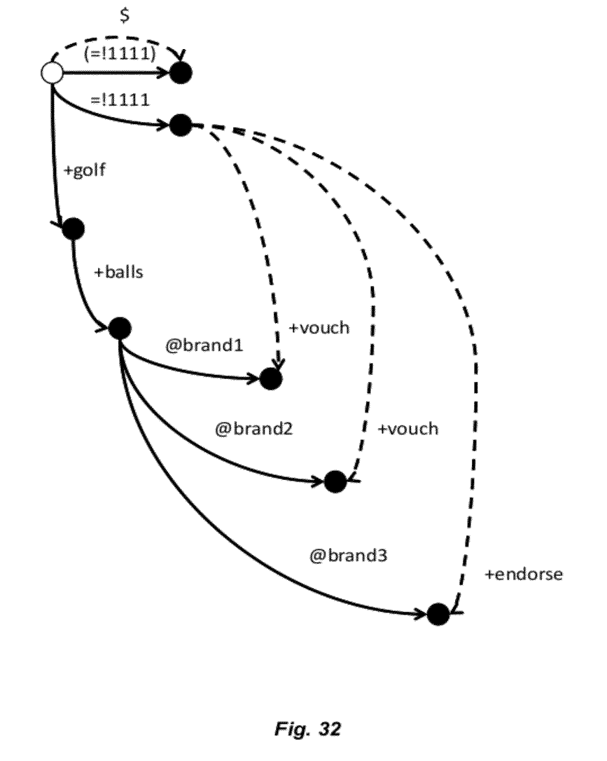

FIG. 32 illustrates an example XDI graph representing an endorsement relationship. In this figure digital identity =!1111 has vouched for @brand1 and @brand2 in the context of +golf+balls. This is acceptable because vouches are not required to be unique in a context. FIG. 32 also shows that =!1111 has endorsed just one brand, @brand3, in that same context. Because endorsements must be unique in a context, =!1111 may not endorse another brand in the +golf+balls context.

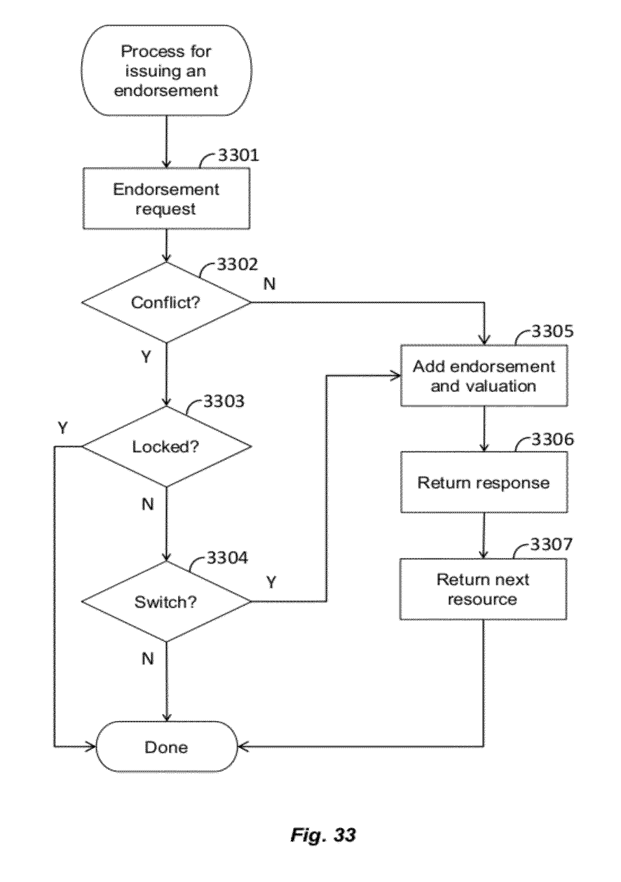

FIG. 33 illustrates an example method for issuing an endorsement. In step 3301 the principal initiates an endorsement request in the same way the principal would initiate a connection request, such as by clicking on a connect button or an option in a connection negotiation offer. In step 3302 the principal's agent processes the endorsement request and determines if there is a conflict, i.e., if the principal has made another endorsement in the same context. If not, the process proceeds with step 3305. If there is a conflict, in step 3303 the principal's agent determines if the existing endorsement is in a “lockdown” period. In one embodiment, to prevent gaming, endorsements include a period during which they cannot be switched. If the existing endorsement falls within this period, the endorsement request cannot be fulfilled and the process ends. If the endorsement is not locked, the principal must make the choice of whether to switch from endorsing one brand to endorsing another. If the decision is not to switch, the process ends. If the decision is to switch, in step 3305 the principal's agent adds the endorsement and any associated valuation to the principal's logical graph. In step 3306 the principal's agent returns a response accepting the endorsement request to the site's agent, which adds the endorsement and valuation to the site's logical graph. In step 3307 the site returns the next resource to the principal based on the principal's new state of having established an endorsement with the site at an established valuation.

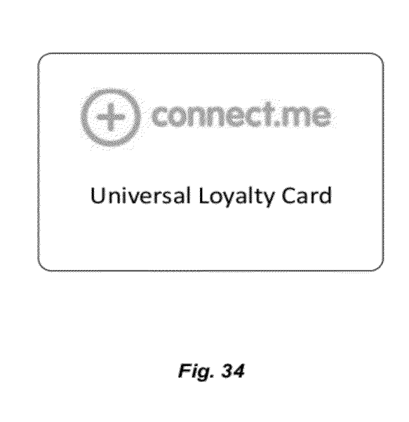

FIG. 34 illustrates an example universal loyalty card in the form of a conventional plastic wallet card or smart card. In an embodiment of the present invention, a principal may form connections and engage in relationship value exchange via the trust network using such a universal loyalty card. Such a card may be in any form a principal can carry, including a smart card, USB key, or RFID chip. It may also take the form of hardware or software operating on a mobile phone or smartphone. Such a card has the advantages of enabling a principal to: a) consolidate a walletful of loyalty cards into a single card with a single online agent and dashboard, b) perform automatic or one-click enrollment in new loyalty relationships, c) aggregate and control any number of loyalty relationships via the trust network, d) share loyalty relationship data and currency across multiple loyalty relationships, and e) automatically record purchases and digital receipts via their agent.

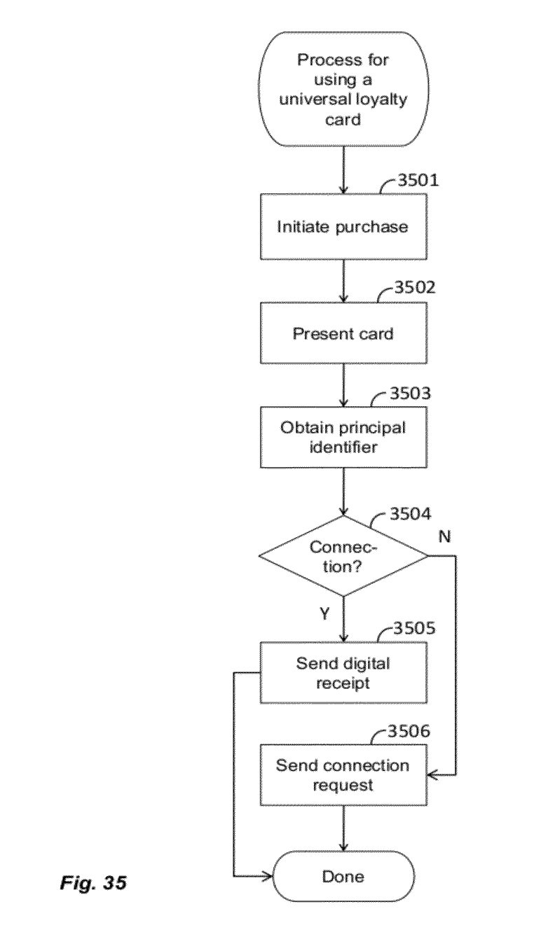

FIG. 35 illustrates an example method for using a universal loyalty card with the trust network of the present invention. In step 3501 the principal initiates a purchase that qualifies for a loyalty relationship. In step 3502 the principal presents the universal loyalty card. In step 3503 the seller's agent processes the universal loyalty card to obtain the principal's identifier on the trust network. This step may involve any hardware, software, or combination thereof that achieves this objective, including point of sale terminals, bar code scanners, RFID scanners, mobile barcode scanners, NFC receivers, and so on. The method of obtaining the principal identifier is not a limiting feature of the invention. In step 3504 the seller's agent searches the seller's logical graph to determine if a connection already exists. In an embodiment using the XDI protocol and graph model, this connection is instantiated as a link contract granting the seller permission to add digital receipts to the principal's logical graph. If found, the seller's agent proceeds to step 3505 where it sends a digital receipt for the purchase in the form of an XDI $add message to the principal's agent at the principal's XDI endpoint. The principal's agent adds it to the principal's logical graph and the process is complete. If a connection does not exist in step 3504, the seller sends a connection request to the principal's agent including the link contract the seller proposes to add to the principal's logical graph to add the principal to the seller's loyalty program. Depending on the principal's rules, this connection request may be automatically approved by the principal's agent, or it may be held or forwarded to the principal for approval.

An embodiment of the present invention relates to a computer storage product with a computer readable storage medium having computer code thereon for performing various computer-implemented operations. The media and computer code may be those specially designed and constructed for the purposes of the present invention, or they may be of the kind well known and available to those having skill in the computer software arts. Examples of computer-readable media include, but are not limited to: magnetic media such as hard disks, floppy disks, and magnetic tape; optical media such as CD-ROMs, DVDs and holographic devices; magneto-optical media; and hardware devices that are specially configured to store and execute program code, such as application-specific integrated circuits (“ASICs”), programmable logic devices (“PLDs”) and ROM and RAM devices. Examples of computer code include machine code, such as produced by a compiler, and files containing higher-level code that are executed by a computer using an interpreter. For example, an embodiment of the invention may be implemented using JAVA®, C++, or other object-oriented programming language and development tools. Another embodiment of the invention may be implemented in hardwired circuitry in place of, or in combination with, machine-executable software instructions.

The foregoing description, for purposes of explanation, used specific nomenclature to provide a thorough understanding of the invention. However, it will be apparent to one skilled in the art that specific details are not required in order to practice the invention. Thus, the foregoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications, they thereby enable others skilled in the art to best utilize the invention and various embodiments with various modifications as are suited to the particular use contemplated. It is intended that the following claims and their equivalents define the scope of the invention.

What is claimed is:

1. A computer readable storage medium, comprising instructions to:
receive a request from a client to enroll in a trust network, wherein the trust network is a group of entities that communicate in a digital network where communications between the entities are quantified to produce measures of entity trustworthiness;
supply a registration form to the client in response to the request; and
process client data in the registration form received from the client, wherein the instructions to process include instructions to load the client data as parameters in a managed trust network.

2. The computer readable storage medium of claim 1 wherein the parameters include a numeric digital identity of the client.

3. The computer readable storage medium of claim 2 wherein the parameters include a named digital identity of the client.

4. The computer readable storage medium of claim 3 wherein the parameters include a synonym relation between the numeric digital identity and the named digital identity.

5. The computer readable storage medium of claim 1 wherein the parameters include contextual data that characterizes a set of circumstances within a digital network in which an individual action transpires.

6. The computer readable storage medium of claim 1 wherein the parameters include contractual data that characterizes an agreement between parties in a digital network which ascribes rights and obligations upon the parties.

7. The computer readable storage medium of claim 1 wherein the parameters include defined rights between the client, the managed trust network and a data service provider.

8. The computer readable storage medium of claim 1 further comprising instructions to:
specify a relationship between a ranking user and a ranked user;
define a context for an attribute of the ranked user, wherein the context characterizes a set of circumstances within a digital network in which an individual action transpires; and
assign a rank value to the ranked user based upon the relationship and the context.

9. The computer readable storage medium of claim 8 further comprising instructions to compute a vouch ratio for the ranked user, wherein the vouch ratio divides the incoming vouches for the ranked user by the outgoing vouches by the ranked user.

10. The computer readable storage medium of claim 9 further comprising instructions to publish the vouch ratio for the ranked user.

11. The computer readable storage medium of claim 9 further comprising instructions to define a threshold vouch ratio required to send an outgoing vouch.

12. The computer readable storage medium of claim 1 further comprising instructions to:
determine if a contextual link exists between a complainant and a recipient as a first check;
decide if a complaint corresponds to the contextual link as a second check; and
if the first check and the second check are satisfied, invoke a complaint resolution mechanism.

13. The computer readable storage medium of claim 12 wherein the complaint resolution mechanism includes an automated iterative collection of information from the complainant and the recipient.

14. The computer readable storage medium of claim 12 wherein the complaint resolution mechanism includes an invocation of trust anchors to form a panel.

15. The computer readable storage medium of claim 12 wherein the complaint resolution mechanism includes instructions to delete a complaint from reputation data.

16. The computer readable storage medium of claim 1 further comprising instructions to:
evaluate parameters in a managed trust network to ascribe a level of trust to be afforded a provider for personal data shared within the managed trust network; and
display indicia of the level of trust.

17. The computer readable storage medium of claim 16 wherein the level of trust is used to manage the exchange of payments.

18. The computer readable storage medium of claim 16 wherein the level of trust is used to manage the exchange of relationship values.

19. The computer readable storage medium of claim 1 further comprising instructions to:
evaluate parameters in a managed trust network to a ascribe a level of trust to a member within the managed trust network; and
convert the level of trust to a digital currency.

20. The computer readable storage medium of claim 19 wherein the digital currency is a financial currency.

21. The computer readable storage medium of claim 19 wherein the digital currency is a reputation currency.

22. The computer readable storage medium of claim 19 wherein the instructions to evaluate are executed by a service provider operating as a broker for relationship value transactions amongst multiple sites.

23. The computer readable storage medium of claim 19 wherein the digital currency is defined by market factors.

24. The computer readable storage medium of claim 19 further comprising instructions to process the digital currency in connection with a group purchasing mechanism.

25. The computer readable storage medium of claim 1 further comprising instructions to:
specify a relationship between a ranking user and a ranked user;
define a context for an attribute of the ranked user; and
assign a rank value to the ranked user based upon the relationship and an exclusive endorsement in the context.

26. The computer readable storage medium of claim 25 further comprising instructions to publish the rank value.

27. The computer readable storage medium of claim 1 further comprising instructions to:
aggregate for an entity a plurality of loyalty relationships in the managed trust network; and
condense the plurality of loyalty relationships into an entity online loyalty agent.

28. The computer readable storage medium of claim 27 further comprising instructions to employ the entity online loyalty agent to facilitate one-click enrollment in a new loyalty relationship.

29. The computer readable storage medium of claim 27 further comprising instructions to utilize the entity online loyalty agent to share loyalty relationship data across a plurality of loyalty relationships.

30. The computer readable storage medium of claim 27 further comprising instructions to utilize the entity online loyalty agent to share currency across a plurality of loyalty relationships.

31. The computer readable storage medium of claim 27 further comprising instructions to utilize the entity online loyalty agent to automatically record purchases.

32. The computer readable storage medium of claim 27 further comprising instructions to utilize the entity online loyalty agent to automatically record digital receipts.
